(19) United States
(12) Patent Application Publication
(10) Pub. No.: US 2010/0315280 A1
(43) Pub. Date: Dec. 16, 2010

(54) Multi-Platform Radar with Forced Resonating Antennas for Embedded Detection and Volumetric Imaging

(76) Inventor: Khosrow Bakhtar, Newport Beach, CA (US)

Correspondence Address: STETINA BRUNDA GARRED & BRUCKER, 75 ENTERPRISE, SUITE 250, ALISO VIEJO, CA, 92656, US

(21) Appl. No.: 12/814,329

(22) Filed: Jun. 11, 2010

Related U.S. Application Data
(60) Provisional application No. 61/186,738, filed on Jun. 12, 2009.

(51) Int. Cl. G01S 13/00

(52) U.S. Cl. 342/22

(57) ABSTRACT

An electromagnetic interrogation system and methods for analyzing a target in a test bed are disclosed. A forced resonating antenna unit has a transmit element and a receive element both mounted on a platform movable over the test bed. An interrogation signal source generates a continuous stepped-frequency radio frequency (RF) signal. A plurality of receiver channels are connected to the receive element, and ratios of the scattered continuous stepped-frequency RF signal on a first one of the receiver channels and on a second one of the receiver channels each relative to a reference one of the receiver channels is derived as a measurement for each frequency step. A triggering module linked to the receiver channels generates a positional data value corresponding to a set of measurements for one or more stepped frequency sweeps. An analysis module generates test bed analysis results based upon multiple sets of measurements over time and the corresponding positional data values.

### CROSS-REFERENCE TO RELATED APPLICATIONS

This application relates to and claims the benefit of U.S. Provisional Application No. 61/186,738 filed Jun. 12, 2009 and entitled “BAKHTARRADAR WITH FORCED RESONATING ANTENNAE FOR EMBEDDED DETECTION AND VOLUMETRIC IMAGING,” the entire contents of which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to radar detection, mapping, and volumetric imaging of concealed targets in natural and man-made media, and more particularly, to stepped frequency near-field radar systems with forced resonating antennas.

2. Related Art

A variety of techniques are known in the art for non-destructively interrogating obstructed targets within large scale test beds such as the Earth's subsurface or building structures, as well as smaller scale test beds such as human bodies, small containers, and so forth. At the most general level, these techniques involve directing reference electromagnetic waves to the target, and subsequently measuring its reflection, absorption, and/or transmission characteristics to ascertain the target. For geophysical imaging, ground penetrating radar (GPR), as well as seismic tomography and electrical resistance tomography may be utilized. For medical imaging, X-ray based modalities such as Computer Tomography (CT), projectional radiographs, etc. are commonly utilized, as well as Gamma ray based modalities such as Positron Emission Tomography (PET), and magnetic field-based modalities such as Magnetic Resonance Imaging (MRI).

Radar was originally developed for the detection and tracking of remote objects from a base station, and employs radio waves having a frequency ranging from a few MHz to several hundred GHz. The base station had a transmitter that emitted the radio waves, and upon contact with an object, they are scattered in many directions. A receiver, which is typically co-located with the transmitter, detected the scattered radio waves. The distance to the object was calculated from the time the radio wave took to return, and the direction of the object was based upon the orientation of the receiving antenna. The speed of the object could also be calculated from the frequency shift (Doppler shift) between the transmitted radio waves and the detected radio waves.

Radar conventionally finds many applications, including meteorological detection, air traffic control, missile control, automated traffic regulation, and so forth. As briefly noted above, however, radar can also be utilized for geophysical imaging in land and marine environments. Additionally, radar can been utilized in biological and medical imaging and diagnostics, as well as security screening due to the lack of ionization radiation being directed into the test bed/human body. While excellent resolution may be achieved in these applications by the use of conventional X-ray based modalities, radar-based systems have lower power requirements and are less complex. Known radar-based interrogation techniques, however, suffer from signal attenuation attributable to “skin depth” effects, and thus are limited to very shallow depths/distances. The directing of electromagnetic energy in to heterogeneous and anisotropic systems is currently understood to result in the acquisition of signals contaminated with substantial noise. This is the case for either transmission through the test bed, where the transmit antenna is located on the opposite side of the test bed if the receive antenna, or reflection, where the transmit and receive antennas are located on the same side of the test bed. Conventional filtering techniques such high-pass and low-pass removes some noise, a substantial portion of the signal may also be lost.

Existing ground penetrating radar systems commonly fall into one of two categories: impulse and continuous wave. Each of these have associated complications arising from the time-varying statistical properties of the signal, as well as the test parameters used for data collection, thereby impacting the signal acquisition and control process. With impulse signals, a wide-band, non-dispersive time domain pulse is transmitted and the reflected energy is received as a function of time. The resulting waveform indicates the amplitude of energy scattered from the target versus time. As the name suggests, a continuous wave system employs a continuous sinusoidal signal, and may be stepped or sequentially change the frequency over time. The reflected energy is received as a function of frequency and indicates the amplitude of energy scattered from the target. A periodic impulse signal contains a wide band of spectral lines, so an impulse wave-based system involves the measurement of the target frequency response simultaneously over the entire band. In contrast, with a stepped frequency signal, the target frequency response is sequentially measured.

Ground penetrating radar, and radar in general, are based off Maxwell's equations, which mathematically describe the physics of electromagnetic fields. Further, the constitutive equations describe the responses of a material to electromagnetic fields, and together serve as the foundation for radar systems. It is noted that Maxwell's equations do not have frequency terms at rest. The constitutive equations incorporate values of permittivity (ε), permeability (μ) and conductivity (σ), which may be functions of location and time. Due to heterogeneity and anisotropic conditions of materials that comprise the test bed, these values are typically represented as tensors such as ε(x, y, z, t), μ(x, y, z, t), and σ(x, y, z, t) in a coordinate system. These parameters can be expressed in terms of frequency by limiting applicability to steady state conditions, but the generality of Maxwell's theory is lost. These equations may be useful for applications such as power transmission where the interest is in power and energy, not cause and effect; in signal transmission, the interest is in the detectable portion of the energy, and not on the energy itself.

Accordingly, there is a need in the art for an improved radar-based detection, mapping, and volumetric imaging system of targets utilizing an alternative approach to avoid the foregoing limitations of conventional radar-based interrogation systems.

### BRIEF SUMMARY

The present disclosure contemplates systems for non-invasive interrogations related to targeted object anomaly detection and volumetric imaging in diverse areas including the medical field for human body scanning and volumetric imaging to locate cancerous tumors, broken bones, artery blockage and so forth, as well as detection of imaging of contents of sealed metallic containers. Additionally, the mapping and volumetric imaging of subsurface openings and structures as well as mapping and volumetric imaging of objects concealed underwater and embedded in the seabed are contemplated. Furthermore, the detection and volumetric imaging of buried human remains and metallic and non-metallic objects buried at various depths below the earth surface. For these purposes and more, various hardware and software configurations are contemplated, including antenna design to enable force resonating the low power electromagnetic energy to reach the desired depth/distance and allow the return to be used for target detection and volumetric imaging. A statistical discriminator filter to identify targets based on intrinsic material properties while masking the rest of the constituent portions of the test bed is also contemplated. A laser distance measuring system enhances the volumetric imaging capabilities. The signal transmission can be either under reflection or transmission mode depending on the location and size of the test bed.

In accordance with one embodiment, an electromagnetic interrogation system for analyzing a target embedded in a test bed is contemplated. The system may include a forced resonating antenna unit that has a transmit element and a receive element mounted on a platform movable over the test bed. There may also be an interrogation signal source that generates a continuous stepped-frequency radio frequency (RF) signal. The interrogation signal source may be connected to the transmit element of the forced resonating antenna over a first transmission line. There may also be a plurality of receiver channels that are connected to the receive element of the forced resonating antenna over a second transmission line. Ratios of the scattered continuous stepped-frequency RF signal on a first one of the receiver channels and on a second one of the receiver channels each relative to a reference one of the receiver channels may be derived as a measurement for each frequency step. The interrogation system may also include a triggering module that is linked to the receiver channels. The triggering module may generate a positional data value corresponding to a set of measurements for one or more stepped frequency sweeps. There may also be an analysis module for generating test bed analysis results based upon multiple sets of measurements over time and the corresponding positional data values received by the analysis module.

According to another embodiment, a method for interrogating a target embedded in a test bed is contemplated. The method may include triggering the transmission of a continuous stepped-frequency RF signal to the test bed through a transmit forced resonating antenna traversing the test bed along a first axis. The method may also include directing the sampling of the scattered continuous stepped-frequency RF signal through a receive antenna as first sets of discrete measurements across a first axis of the test bed. The first sets of discrete measurements may be in a frequency domain format represented as complex values that include magnitude terms and phase terms. There may be a step of transforming the first sets of discrete measurements from the frequency domain format to a time domain format. Additionally, there may be a step of generating first traces of real values of the first sets of discrete measurements in the time domain format from the corresponding complex values. The first traces may correspond to a cross-sectional representation of the target and the test bed.

In another embodiment, there may be a method for tuning a forced resonating antenna utilized in the interrogation of a test bed for a target. The method may include measuring the electromagnetic wave speed for the test bed, as well as deriving a fundamental complex frequency value with a magnitude component and a phase component based upon the measured electromagnetic wave speed for the test bed. There may be a step of deriving a complex frequency spectrum for an operating range of the antenna from the derived fundamental complex frequency value. Further, the method may include forced resonating a prototype antenna circuit including an antenna element and resistance, capacitive reactance, and inductive reactance components with initial values corresponding to the complex frequency spectrum. The prototype antenna circuit may be forced resonated at the fundamental complex frequency value, an odd harmonic of the fundamental complex frequency value, and an even harmonic of the fundamental complex frequency value. The method may include balancing the prototype antenna circuit for a predefined impedance value. There may also be a step of substituting each of the inductive reactance and capacitive reactance components of the prototype antenna circuit with resistive components while substantially matching the predefined impedance value. An optimized prototype antenna circuit may be the tuned forced resonating antenna.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram of one embodiment of a forced-resonance electromagnetic interrogation system;

FIG. 2 is a block diagram illustrating an embodiment of the interrogation system with a macro type triggering system for larger scale test beds;

FIG. 3 is a block diagram illustrating a different embodiment of the interrogation system with a micro type triggering system for smaller scale test beds;

FIG. 4 is a flowchart of a method for interrogating the target embedded in the test bed;

FIG. 5 is a circuit diagram of a Thévenin equivalent circuit of a forced resonating antenna of the interrogation system in a transmit mode;

FIG. 6 is a flowchart of a method for tuning a forced resonating antenna in accordance with one embodiment of the present disclosure;

FIG. 7 depicts vectors in a rosette arrangement for measuring electromagnetic wave speed;

FIG. 8 is a schematic diagram of a simplified receive antenna equivalent circuit;

FIG. 9 is a schematic diagram of a simplified transmit antenna equivalent circuit;

FIG. 10 is a bottom view of the forced resonating antenna;

FIG. 11 is an example setup window of a controller application implementing various methods of the present disclosure;

FIG. 12 is an example acquisition window of the controller application;

FIG. 13A is a plot of a windowing function showing a rippled effect with a discrete representation of a rectangular window;

FIG. 13B is a plot of a von Hann window;

FIG. 14 is an example replay window of the controller application;

FIG. 15 is a flowchart describing a method for constructing a volumetric image of the target and the test bed;

FIG. 16 is an example two-dimensional plot of the test bed in a threshold format;

FIG. 17 is an example volumetric representation of the test bed of FIG. 16 including an embedded object;

FIG. 18 is a tomographic section generated by the interrogation system, showing a buried human remains after 75 years;

FIG. 19 is an image of a radiology phantom showing the test object insert as interrogated with the forced resonating antenna;

FIG. 20A is a computed tomography section through an orange as interrogated with the forced resonating antenna;

FIG. 20B is a computed tomography section through an apple as interrogated with the forced resonating antenna;

FIG. 20C is a computed tomography section through an egg as interrogated with the forced resonating antenna;

FIG. 21 is a normalized plot showing the detection capabilities of the interrogation system with the orange of FIG. 20A, the apple of FIG. 20B, and the egg of FIG. 20C;

FIG. 22 is a cross sectional diagram of a double shielded lead aluminum container filled with 3.5% salt saturated sand; and

FIG. 23 is normalized plot showing various specimens detected through the container shown in FIG. 22.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

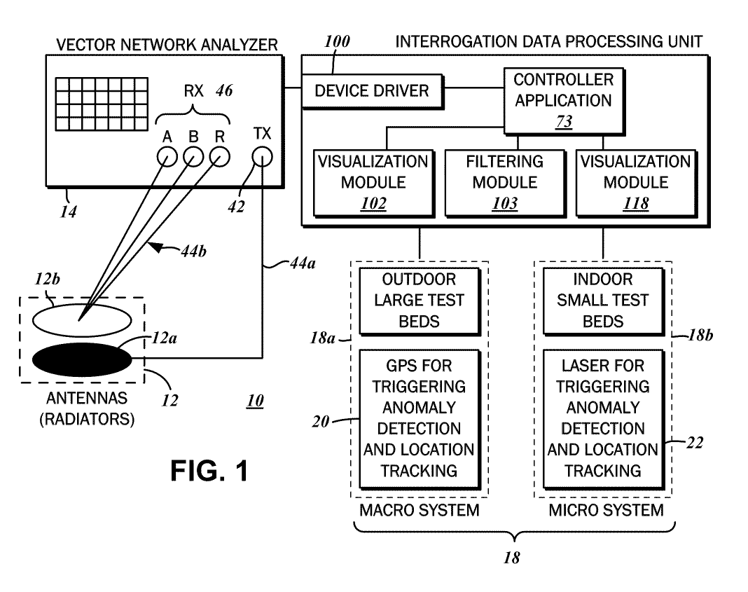

With reference to the block diagram of FIG. 1, various embodiments of the present disclosure contemplate a low-power, forced-resonance electromagnetic interrogation system 10 based on the near-field stepped frequency radar principle. The interrogation system 10 non-invasively detects and images various targets embedded in a test bed, and various embodiments further contemplate methods therefor. The test bed may be any natural media such as geologic systems including saline water and the seabed, the human body, and any man-made articles such as vehicles, metallic and non-metallic containers, and the like.

As shown in FIG. 1, the interrogation system 10 includes a pair of wide aperture forced resonating antennas 12, and the present disclosure also contemplates a method for tuning the same. The antennas 12 may be further characterized as a transmit element 12a and a receive element 12b, and together may be referred to as a forced resonating antenna unit. More particularly, the antennas 12 are forced resonated at extremely low power or energy levels outside of natural or fundamental frequencies thereof. The operating frequency band of the forced resonating antenna 12 can be adjusted to detect test beds of varying depths and the specific depths of interest of the targets. The forced resonating technique of the present disclosure greatly enhances target detection, as skin and Faraday's cage effects are overcome and interrogating energy can be transmitted to much greater depths. Detection depth is largely a function of the aperture size of the antenna 12, and not dependent on the characteristics of the test bed.

The forced resonating antennas 12 may be configured for transmission mode, where the receive element 12b is opposite the test bed to the transmit element 12a, or for reflection mode, where both the transmit and receive elements 12a, 12b, respectively, are on the same side of the test bed. In the transmission mode, the forward signal through the test bed is detected, where in the reflection mode, the backscattered weaker return signal from the test bed is detected.

In addition to the forced resonating antenna 12, the interrogation system 10 includes a vector network analyzer unit 14 that generates and detects the radar signals, as well as an interrogation data processing unit 16. In addition to coordinating the operation of the vector network analyzer 14 and the triggering module 18, the interrogation data processing unit 16, also generally referred to as an analysis module, performs statistical digital filtering, along with a volumetric imaging and four-dimensional visualization.

Generally, the test bed is interrogated by moving the forced resonating antennas 12 across an area of interest. In order to correlate the radar signals to a particular location, the interrogation system 10 includes a triggering module 18. The triggering module 18 is linked to the interrogation data processing unit 16 to generate positional data values corresponding to a set of measurements for one or more stepped frequency sweeps. The interrogation data processing unit 16 generates test bed analysis results based upon this data.

As noted above, the interrogation system 10 is capable of interrogating test beds for a variety of different applications, including medical screening, earth/ground inspections, ocean/seabed inspections, and so forth. As can be appreciated, these applications vary substantially in scale, and so the distance that the forced resonating antennas 12 are moved likewise varies in scale. Accordingly, the triggering module 18 can be of a macro type 18a that is suitable for large, outdoor environments such as earth/ground and ocean/seabed interrogations, and a micro type 18b that is suitable for smaller, indoor environments such as container interrogation and medical imaging. The macro type 18a includes a global positioning satellite (GPS) receiver 20, while the micro type 18 includes a laser distance measuring device 22. The GPS receiver 20 and the laser distance measuring device 22 are not intended to be used exclusively with respect to each other, and certain embodiments may utilize both concurrently. Depending on the scale of the test bed, the forced resonating antennas 12 may be integrated into a moving platform including the other noted components, or be installed on a specialized antenna platform.

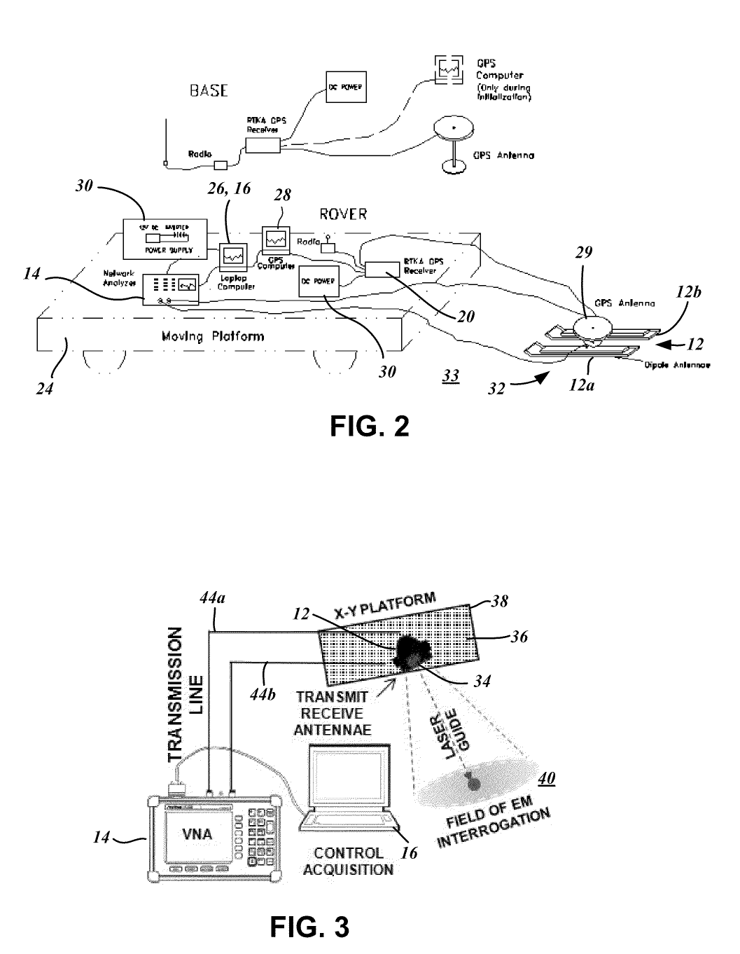

FIG. 2 illustrates one embodiment of the interrogation system 10 where most of the components are integrated on a wheeled platform 24, and utilizes a macro type triggering module 18a. The vector network analyzer unit 14 is mounted to the wheeled platform 24, as well as a laptop computer 26 corresponding to the interrogation data processing unit 16, and the GPS receiver 20. There may also be a GPS computer 28 in communication with the laptop computer 26, which, in combination with the GPS receiver 20, coordinates the triggering functions noted above. Each of the foregoing components mounted on the wheeled platform 24 may be powered by various power supplies 30. The forced resonating antennas 12 may be mounted on an antenna platform 32 that is separate from the wheeled platform 24. As part of the triggering module 18, there is a GPS antenna 29 that is mounted on the antenna platform 32 in this embodiment. The antenna platform 32 directly interfaces with a sample test bed 33, which in this case is the earth.

FIG. 3 illustrates another embodiment of the interrogation system 10 with a micro type triggering module 18b and the antenna 12 is movable. This embodiment also includes the vector network analyzer 14 and an interrogation data processing unit 16, but unlike the above, these components do not move during interrogation. Instead, an antenna mount 34 with the antenna 12 moves along a planar platform 38. A laser guide 36 detects the relative position of the antenna mount 34 with respect to the planar platform 38, and coordinate values are generated thereby. The antenna 12 directly interfaces with a sample test bed 40. In accordance with this embodiment, the antenna 12 is of the horn type, though any other suitable type may be readily substituted without departing from the present disclosure. This configuration, as well as the specific macro type discussed above, employs the reflective mode. To the extent that a transmission mode is employed, corresponding changes therefore are also contemplated. Specifically, there may be a separate receive antenna mount that may be mechanically or otherwise coupled to a transmit antenna mount on the other side of the test bed 40.

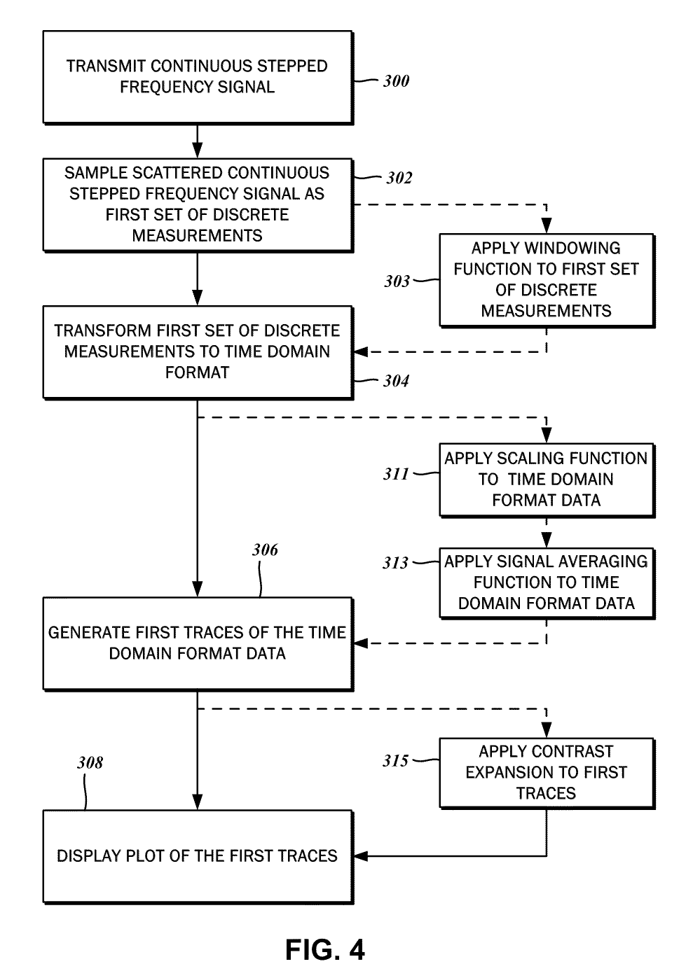

In accordance with one embodiment of the present disclosure, the vector network analyzer 14 includes an interrogation signal source 42 that generates a continuous stepped-frequency radio frequency (RF) signal. As briefly noted above, the present disclosure also contemplates a method for interrogating a target embedded in a test bed, and with reference to FIG. 4, this method begins with a step 300 of triggering the transmission of the continuous stepped-frequency RF signal to the test bed through the transmit forced resonating antenna 12a.

The interrogation signal source 42 is connected to the transmit antenna element 12a over a first transmission line 44a. The generated stepped-frequency RF signal is defined by the following equation:

$$f ( t ) = A {e}^{( j 2 π ( {f}_{1} + n Δ f ) t )} for \{ \frac{( n - 1 )}{N} \} T \leq t \leq ( \frac{n}{N} ) T ; 0 \leq n \leq N - 1$$

where A is the signal magnitude, T is the signal period, N is the total number of frequency steps, ƒ₁ is the step center frequency, and Δƒ is the frequency step interval. It is understood that the stepped frequency RF signal is particularly suitable due to its signal-to-noise ratio in comparison to an impulsive RF signal. The output power may be kept below 10 dBm (10.02 mW) in order to prevent further the domination of noise and the introduction of artifacts into the received signal.

Referring again to the block diagram of FIG. 1, in addition to the interrogation signal source 42, the vector network analyzer 14 has a plurality of receiver channels 46 that are connected to the receive element 12a of the antenna unit 12 over a second transmission line 44b. In accordance with one embodiment, there is first receiver channel A 46a, a second receiver channel B 46b, and a reference receiver channel R 46c, the detailed uses for which will be discussed below.

The vector network analyzer 14 may be any one of several commercially available devices, including the Hewlett-Packard® models 8753D, 8753A, 8712, 8753ES, as well as the Anritsu SiteMaster and Scorpion models. Although the present disclosure shows only a single vector network analyzer 14, additional ones may be added if a higher resolution is necessary to show greater details or if necessary because of the size of potential targets. Generally, the vector network analyzer 14 characterizes the linear system/test bed by comparing the signal applied to the transmit forced resonating antenna 12a to a signal or multiple signals received on the receive antenna 12b. The interrogation system 10 utilizes the vector network analyzer 14 in a forward transmission mode, or S₂₁. In particular, the ratio of the signal on the first receiver channel A 46a in relation to an incident signal on the reference receiver channel R 46c is measured, and the ratio of the signal on the second receiver channel B 46b in relation to the incident signal on the reference receiver channel R 46c is measured. All of the measurements are made with respect to the reference plane, which represents the boundary between the forced resonating antenna unit 12 and the surface of the test bed. Typically, the vector network analyzer has an average transmitter power of 0.01 Watt, and a frequency range of 30 kHz to 3 or 6 GHz. Receiver sensitivity is typically −90 dBmw for a 0 Hz intermediate frequency, and the dynamic range, with 50 dB external amplification, is 170 dB. The test speed is approximately 0.35 seconds per test, for an intermediate frequency of 300 Hz. The resolution is typically 1 Hz. The foregoing specifications have been provided by way of example only, and any other suitable configuration may be substituted.

Sweep time determines the maximum lateral speed of the moving platform (whether in the macro configuration of the micro configuration) with respect to the closest target. Faster sweep rates are understood to correspond to faster lateral scan rates. The maximum sweep rate for a particular interrogation is determined by the maximum target depth or distance, the electromagnetic wave speed within the test bed under interrogation, the receiver bandwidth, the processing speed of the vector network analyzer 14, and the sampling rates of the triggering module 18. Along these lines, the speed of the moving platform is set such that a sweep can be completed before there are too many phase shifts to the point of de-correlating the inverse fast Fourier transform. Although faster sweep times are thus preferable, limitations due to the operating frequency band of the vector network analyzer 14 may not make this possible.

As indicated above, the interrogation signal source 42 applies a continuous frequency ramp to the transmit forced resonating antenna 12a, and to the phase locked receiver channels 46. The return signal to the receiver channels 46 is understood to be delayed in time corresponding to the group delay of the transmission lines 44. The interrogation system 10 is contemplated to compensate for this delay by accounting for the total length of the transmission lines 44, which depends upon the size of the antenna elements 12a, 12b. As will be described in further detail below, the forced resonating antenna unit 12 is particularly configured to account for receiver sensitivity, gain in the antennas 12, transmit to receive isolation. It is understood that test bed characteristics play a limited role in the configuration of the forced resonating antenna unit 12, and its influence can be reduced by adjusting the operating frequencies of the same.

The interrogation data processing unit 16 interfaces directly with the vector network analyzer 14, and controls most operational aspects thereof. Specifically, the intermediate frequency signals utilized for internal processing, the number of points, the output power, and the operating frequency band is set through the interrogation data processing unit 16 and applied to the vector network analyzer 14. The interface with which such control may be implemented may be, for example, the General Purpose Interface Bus (GPIB), which conforms to the Institute of Electrical and Electronics Engineers (IEEE) standard parallel interface. A 24-pin connector may be utilized, and up to fifteen different devices may be interconnected in a daisy-chain configuration. Although no calibration between interrogation data processing unit 16 and the vector network analyzer 14 is necessary, the vector network analyzer 14 itself is calibrated periodically to identify any potential issues resulting from internal dust accumulation and component damage from shocks and vibrations encountered during interrogation.

It will be appreciated that the forced resonating antenna unit 12, as an element of the interrogation system 10, is the transitional structure between the free space/test bed, the vector network analyzer 14, and the transmission lines 44. A properly tuned and configured forced resonating antenna unit 12 improves the quality of reception of the reflected signals, and thus improves target detection/discrimination as well as volumetric imaging and 4-D visualization. With reference again to FIG. 1, the transmission lines 44, which by way of example are coaxial cables, guides the electromagnetic energy from the interrogation signal source 42 to the load or antennas 12 as transverse electromagnetic waves (TEM).

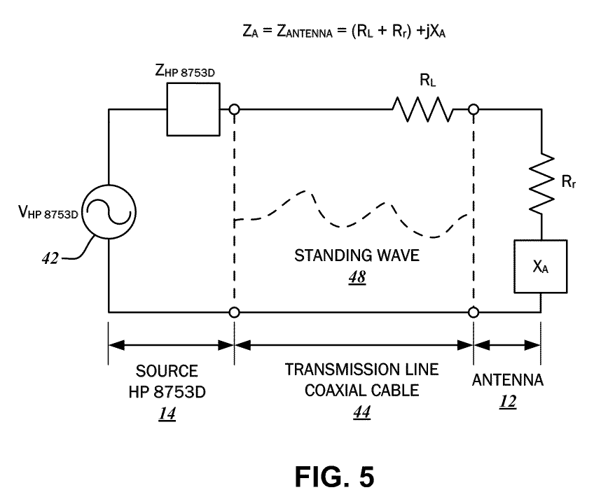

FIG. 5 illustrates the Thévenin equivalent circuit of the forced resonating antenna unit 12, the transmission line 44, and the interrogation signal source 42. Specifically, the forced resonating antenna unit 12 corresponds to load impedance Z_{A}, and the transmission line 44 has a characteristic impedance Z_{C}. The vector network analyzer 14 is assumed to be an ideal generator. During transmission, the load impedance Z_{A} is given by:

Z_{A}=Z_{LOAD}=Z_{ANTENNA}=[(R_{L}+Rᵣ)+jX_{A}]

Where R_{L} is the load resistance, and describes conduction and dielectric losses associated with the structure of the forced resonating antenna unit 12. Furthermore, Rᵣ is the radiation resistance that is associated with the forced resonating antenna unit 12, and X_{A} is the reactance or imaginary part of the impedance of the forced resonating antenna unit 12.

Under ideal conditions, all of the energy generated by the interrogation signal source 42 will be transferred to the forced resonating antenna unit 12, and specifically the antenna radiation resistance Rᵣ. However, in real-world systems, there are conduction-dielectric losses from the transmission lines 44 and the antenna structure, as well as impedance mismatches between the transmission lines 44, couplers, connectors, and the antenna structure that result in signal reflections. Additionally, there is cross-talk between antenna ports on the forced resonating antenna unit 12. Heterogeneity and the isotropic nature of the test bed at different layers and interfaces may also cause reflection and refraction losses. The vector network analyzer 14 may also have losses due to internal impedance. In light of these losses, power to the forced resonating antenna unit 12 may be maximized with conjugate matching.

The combination of losses stemming from reflected waves between mismatched interfaces and losses in the transmission lines 44 create constructive and destructive interference patterns inside the transmission lines 44, also referred to as standing waves 48. The standing waves 48 are understood to represent pockets of energy concentration and storage associated with a resonant device such as dipole antennas. These losses are also considered in tuning and configuring the forced resonating antenna unit 12 to maximize energy transfer. Accordingly, optimizing the interrogation system 10 further involves maintaining the interrogation signal source 42 and the transmission lines 44 and calibrating the same to prevent malfunctions.

The length of the transmission lines 44 are comparatively long, so only a fraction of the guided energy is reflected from the target to provide a return signal for detection. Losses associated with the transmission lines 44 are generally considered unavoidable, however, it is contemplated that certain steps may be taken to minimize such losses. These steps include the selection of low-loss cables to minimize radiation losses along the transmission lines 44, the insertion of ferrite toroidal cores are predetermined intervals along the transmission lines 44 for RF noise suppression, the reduction of antenna loss resistance R_{L}, and the reduction of standing waves by matching the load impedance with the that of the transmission lines 44 and the interrogation signal source 42, among others.

Ideally, the transmission line 44 guides the transverse electromagnetic waves with little radiation, and the forced resonating antenna unit 12 optimizes the radiation into directed energy. The forced resonating antenna unit 12 is understood to be a one port device having an associated impedance over its operating frequency range. As indicated above, the guided energy is transferred through the transmission line 44 and converted into a continuous non-sinusoidal radiating wave, though any continuous wave may be represented as a summation of cosine and sine series. The characteristics and efficiency of the conversion is dependent upon the radiation patterns of the forced resonating antenna unit 12. In addition to the test bed, aspects that influence the radiations from the forced resonating antenna unit 12 include the operating bandwidth, the intermediate frequency selected for processing by the vector network analyzer 14, the number of frequency steps selected for sweep, and the shielding and hardening of the antenna circuitry.

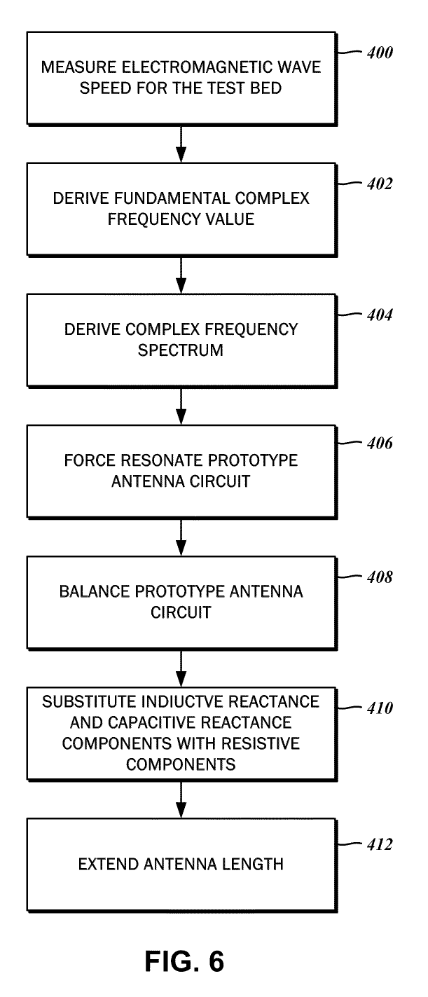

The present disclosure contemplates a method for tuning the forced resonating antenna unit 12 based upon the aforementioned considerations. As shown in the flowchart of FIG. 6, the method begins with a step 400 of measuring the electromagnetic wave speed for the particular test bed. It is understood that the configuration of the forced resonating antenna unit 12 is largely unaffected by the electrical properties of the test bed, and the detection is based upon the prevailing contrast between the intrinsic material properties of the target and those of the test bed. Thus, ascertaining the overall characteristics of the test bed is a part of configuring and tuning the forced resonating antenna unit 12. Additionally, as will be discussed further below, various discriminator filters for identifying targets and masking neighboring test bed materials depends upon this as well. Electromagnetic wave speed measurements are understood to account for the characteristic impedance of the test bed and eliminate the need for measuring permittivity, permeability, and conductivity parameters independently under laboratory conditions, which do not represent the overall characteristics of the test bed within the volume being interrogated. Depending on the size of the test bed, the length vector along which electromagnetic wave speed tests are performed changes from a few centimeters to tens of meters. Measurements are understood not to be affected by the frequency band of operation. The scalar size of the length vector along which measurements are made depends on the depth of interest through a potential test bed.

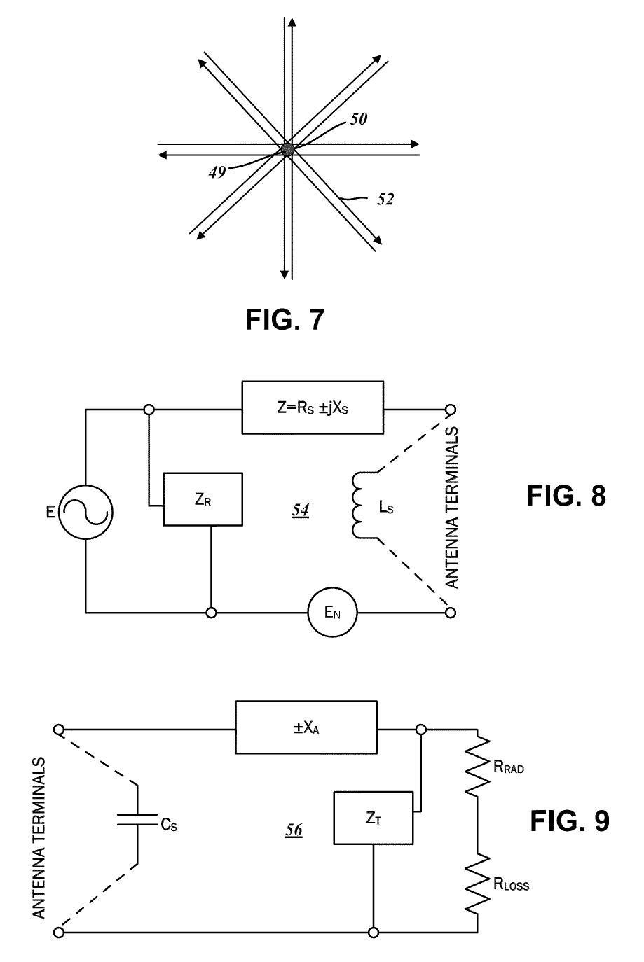

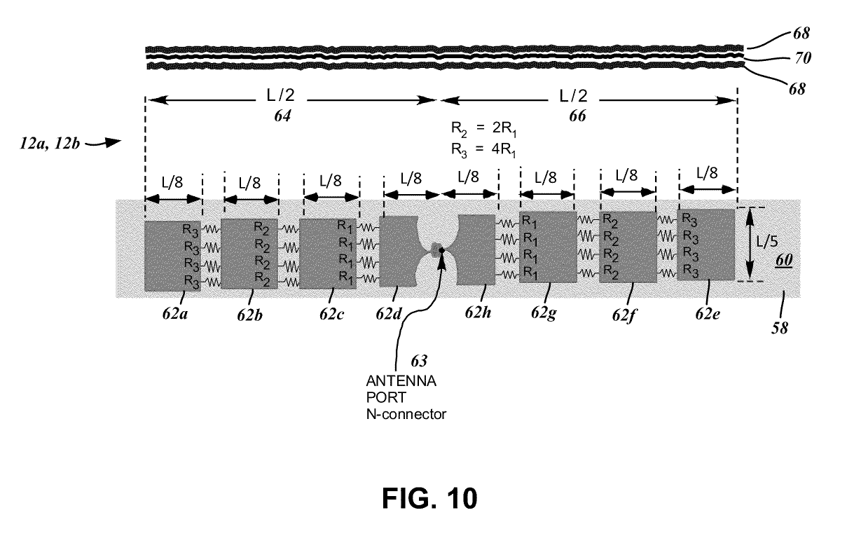

As shown in FIG. 7, the electromagnetic wave speed measurements are made on the surface footprint 49 of the potential target. A pair of antennas including one corresponding to a transmitter and another corresponding to the receiver is utilized. The transmitter antenna is kept stationary at a predetermined position 50 on the test bed, while the receiver is moved away incrementally along predetermined vectors 52 in a rosette configuration. For each increment, the separation from the center of the transmitter antenna and the center of the receiver antenna is recorded as a separate trace. The slope of the distance/depth versus time (in cm/nanoseconds) is understood to correspond to the value of the electromagnetic wave speed in the test bed. Measurements are repeated along each of the vectors 52 of the rosette configuration. A statistically averaged value of each of the recorded electromagnetic wave speed values is calculated, and is understood to account for all electromagnetic and overall characteristics of the test bed.

Referring again to the flowchart of FIG. 6, the method for tuning the forced resonating antenna unit 12 continues with a step 402 of deriving a fundamental complex frequency value with a magnitude component and a phase component. This is understood to be based upon the measured electromagnetic wave speed for the specific test bed for which the forced resonating antenna unit 12 is being tuned. Thereafter, in step 404, the method continues with deriving a complex frequency spectrum for the operating range of the proposed forced resonating antenna unit 12. This is based upon the frequency domain, and the phase component is ignored. A prototype antenna circuit is constructed and force resonated within the simplified complex frequency spectrum at is odd an even harmonics according to a step 406. A simulated tuner and circuit board including resistive, capacitive and inductive linear components may be utilized for this step, and is understood to correspond to the complex frequency spectrum derived in the step 404.

Initially, the component values are selected to balance the circuit to match a 50 ohm impedance in accordance with a step 408.

Next, in a step 410, the inductive reactance and capacitive reactance components are substituted with resistive components with the goal of yielding a 50 ohm overall impedance in a largely trial-and-error procedure. In order to accommodate the additional circuit components and enhance depth penetration, the length of the antenna element is extended per step 412. The resulting frequency spectrum may be monitored with a spectrum analyzer, and the length may be adjusted until the internal impedance is or about 50 ohm. The foregoing trial-and-error procedure is repeated each of the remaining inductive reactance and capacitive reactance components. The adjusted prototype antenna circuit is the forced resonating antenna unit 12 utilized in the interrogation system 10.

FIG. 8 shows a simplified receive antenna equivalent circuit 54 where Z corresponds to the antenna impedance that is represented by a complex form with real part R_{S} and complex part jX_{S}. Lₛ is the shunt inductance. An induced voltage E is understood to be proportional to the length L, with a noise voltage E_{N} that is equivalent to:

[4 K BW T R]^{1/2}

where K is the Boltzmann constant, BW is the bandwidth in Hz, T is the temperature in degrees Kelvin, and R is the loss resistance. Z_{R} is 50 ohm and is the combination of the series and parallel resistive components that are substitutes of the inductive and capacitive reactance components.

FIG. 9 shows a simplified transmit antenna equivalent circuit 56, where X_{A} corresponds to antenna reactance. R_{RAD} is defined as the radiation resistance, and R_{LOSS} is defined as the loss resistance. The sum of these two resistance components is the antenna resistance or R_{A}. C_{S} is the shunt capacitance. Z_{T} is 50 ohm and is the combination of the series and parallel resistive components that are substitutes of the inductive and capacitive reactance components. These resistive components are adjusted in the aforementioned trial-and-error procedure to achieve the 50 ohm internal impedance without the shunt capacitance C_{S}.

Generally, the forced resonating antenna units 12 are tuned to have identical characteristics whether transmitting or receiving. In some embodiments, however, it is expressly contemplated that the receive element may be modified to filter some extraneous multi-path ambient noise by integrating a multi-turn inductor into the resistive circuitry.

With reference to FIG. 1, a bottom view of one embodiment of the force resonating antenna unit 12 is shown. In greater detail, the forced resonating antenna unit 12 is defined by a base 58 having a bottom surface 60 that interfaces with the test bed, and an opposed top surface (not shown). By way of example, the base 58 is constructed of a polyethylene dielectric material. Embedded within the base 58 are a series of copper plates 62 that are approximately 0.7 mm thick. Each of the copper plates 62 are understood to have a length ⅛ the length of the antenna element L, with an equal number of copper plates 62 disposed on a first half 64 and a second half 66. The width of each of the copper plates 62 are understood to be ⅕ the length of the antenna element L. In further detail, the first half 64 has a first copper plate 62a, a second copper plate 62b, a third copper plate 62c and a fourth copper plate 62d. The second half 66 has a fifth copper plate 62e, a sixth copper plate 62f, a seventh copper plate 62g, and a eighth copper plate 62h. Resistive elements R1 electrically connect the fourth copper plate 62d and the third copper plate 62c, as well as the eighth copper plate 62h and the seventh copper plate 62g. Second resistive elements R2 electrically connect the second copper plate 62b to the third copper plate 62c, and the sixth copper plate 62f to the seventh copper plate 62g. Third resistive elements R3 electrically connect the first copper plate 62a to the second copper plate 62b, and the fifth copper plate 62e to the sixth copper plate 62f. It is understood that the second resistive element R2 has a value twice that of the first resistive element R1, and the third resistive element R3 has a value quadruple that of the first resistive element R1. The fourth copper plate 62d and the eighth copper plate 62h are interconnected with an antenna port 63.

After construction of the above, the forced resonating antenna unit 12 may be examined again for

Compatibility with the interrogation signal source 42 and the transmission lines 44 with the vector network analyzer 14. The top surface is 62 is overlaid with a shielding 68, which includes a middle panel 70 sandwiched between a top environmental shield layer 72a and a bottom environmental shield layer 72b. The middle panel 70 may be corrugated aluminum that serves to shield against spurious noise and is thereby electromagnetically hardened. By way of example, the environmental shield layer 72 may be constructed of 3M(™) Scotch-Weld(™) epoxy material, though any other suitable material may be substituted.

As mentioned above, the energy transmitted using the forced resonating antenna unit 12 is in non-sinusoidal form, although any waveform can be represented as a summation of sine and/or cosine series. The forced-resonating signal or energy is understood to interact with a potential target at the atomic level, and the short dwelling time resulting from the step frequency transmission allows energy absorption by the target material at the emission frequency. This is contemplated to facilitate the differentiation from neighboring test bed material. Thus, forced resonance detection employed in the interrogation system 10 is based upon the intrinsic material properties, and not its density. Accordingly, clay-rich geological systems, test beds with moisture content, test beds with salinity, those environments prone to Faraday's cage effects and skin depth effects can still be interrogated to detect and discriminate embedded targets.

With reference again to the flowchart of FIG. 4, the method for interrogating the target embedded in the test bed continues with a step 302 of directing the sampling of the scattered continuous stepped-frequency RF signal through the receive antenna element 12b. As indicated above, the vector network analyzer 14 receives the signal in a forward transmission mode (S₂₁) of data collection. Signal acquisition may be commenced manually for electromagnetic wave speed measurements, triggered continuously, or with the triggering module 18. As the force resonating antenna unit 12 traverses the test bed along a first axis, first sets of discrete measurements are made of the scattered continuous stepped-frequency RF signal. The first sets of discrete measurements are converted to an intermediate frequency for further internal processing, and an anti-alias filter may remove the higher, unwanted frequencies.

As mentioned above, the interrogation data processing unit 16 coordinates the operation of the vector network analyzer 14 including transmitting, receiving, and measuring the interrogating radar signal in coordination with the triggering module 18. The interrogation data processing unit 16 may be a separate computer system that is connected to the vector network analyzer 14 via the GPIB. The computer system may include one or more applications comprised of sets of instructions that implement various contemplated methods of the present disclosure. Namely, there is a controller application 73. According to one embodiment, the computer system is a conventional Windows-based personal computer, and the controller application 73 may be built on the LabWindows development system. This development system includes libraries of functions that aid in creating data acquisition and instrument control panels and control routines. Additionally, graphical user interfaces (GUIs) development is streamlined, and several signal processing algorithms are available for invocation. Due to its modular nature, alternative signal display and signal processing functions can be developed and utilized.

Several of the steps of the method for interrogating the target embedded in the test bed have been described above, including triggering the transmission of the interrogating radar signal as in step 300, and then directing the sampling of the scattered signal as in step 302. The specific way these functions are performed is managed by the controller application 73 that is running on the interrogation data processing unit 16. In this regard, various operational parameters may be modified by providing corresponding initialization data that is specific to the test bed that is being investigated. This initialization data may be entered by a user interactively via a graphical user interface that includes menus, panels, controls, and dialog boxes. Flexibility in choosing the acquisition parameters is thus provided, so that interrogations may be optimized for signal strength and signal frequency range for a specific test bed/target combination, which is characterized by target geometry, composition, depth of burial or distance from receiving antenna, and the test bed features.

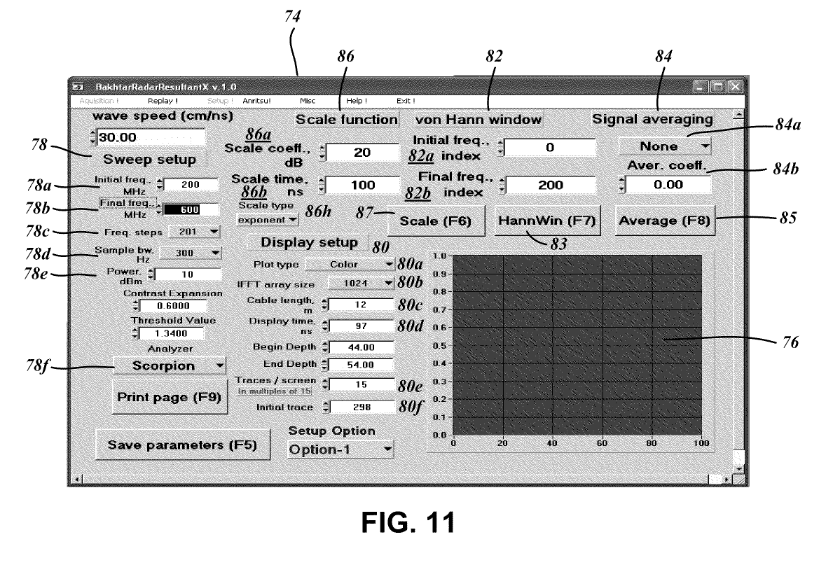

With reference to the example screen captures shown in FIGS. 11, a setup window 74 accepts values of operational parameters that are used to control signal acquisition, and certain aspects of signal processing and display. Generally, the setup window 74 includes various parameter control buttons and a graph area 76 for viewing plots of processing functions. Data entered via the setup window 74 may be saved to an external file for subsequent retrieval and use. Before committing the inputted data, it may be checked to verify that they are within valid ranges. The setup window 74 is segregated into several sections, including a sweep setup section 78, a display setup section 80, a von Hann window section 82, a signal averaging section 84, and a scaling function section 86. Each of the parameters in these different sections will be detailed below.

Under the sweep setup section 78 there are parameters associated with signal sampling. In particular, the parameter 78a labeled “Initial freq.” defines the frequency at which to begin sampling; the range is contemplated to be 1 MHz to 8000 MHz, though higher and lower frequencies can be specified. The parameter 78b labeled “Final freq.” defines the frequency at which to end sampling, and together with the parameter 78a, controls the total sampling frequency range. Differing site characteristics such as target material, depth of burial, and ground composition may be considered in determining the most effective range. It is understood that a higher frequency range is typically utilized for shallow depths and when finer target detail is needed. On the other hand, a lower frequency range is suitable for greater target location depths and deeper signal penetration. The contemplated range is, again, 1 MHz to 8000 MHz.

The parameter 78c labeled “Freq. steps” defines the size, or the number of entries of a sample frequency array. The array size may be 51, 101, or 201, though any other size may be pre-programmed to the extent necessary. Each entry in the array is known to represent a magnitude value sampled at a frequency which is: initial frequency+(sample bandwidth/array size)*i, where i is the entry number. At any given bandwidth, the larger the size of the array, the finer the signal resolution will be, along with a corresponding increase in memory usage.

The parameter 78d labeled “Sample bw.” defines the frequency bandwidth covered by each data sample in Hz. It can be one of 3000, 300, or 30 Hz. A smaller bandwidth increases the time taken to perform the signal measurement, and is directly related to the noise floor of a given configuration.

The parameter 78e labeled “Power” is the output power generated by the interrogation signal source 42 of the vector network analyzer 14, specified in dBm. Generally, the value is set to below 10 dBm.

The parameter 78f labeled “Analyzer” accepts the choice of the model of the vector network analyzer 14. As indicated above, several embodiments of the interrogation system 10 contemplate the incorporation of Hewlett-Packard and Anritsu vector network analyzers 14, and the specific compatible models may be listed under the parameter 78f. To the extent that other compatible vector network analyzers 14 are added, those may likewise be listed under the parameter 78f.

From the parameters under the display setup section 80, different plotting features may be selected. The parameter 80a labeled “Plot type,” defines the type of plot that will be generated in subsequent steps. By way of example, the plot type may be one of color, grayscale, or wiggle plot. The parameter 80b labeled “IFFT array size” specifies the length of the array used for the inverse Fourier transform function of the acquired data, the details of which will be considered more fully below. The value can be set to 512 or 1024 entries, and the array is understood to be longer than the acquired frequency domain signal to allow for “wrap around” data because of the assumed periodicity of the discretely sampled signal.

The parameter 80c labeled “Cable length” specifies the length of the transmission line 44 that connects the vector network analyzer 44 to the forced resonating antenna 12. As discussed above, the associated group delay is compensated, and it is through this parameter that the extent of compensation is specified. In particular, the additional signature resulting from the signal travel along the transmission line 44 is subtracted from the input data; only the data received from the test bed will be plotted. The length is the total length of both the transmit transmission line 44a and the receive transmission line 44b. The parameter 80d labeled “Display time” specifies the portion of the total signal, in nanoseconds, to be displayed. This value is used along with the electromagnetic wave speed measurement to determine the distance or depth displayed. The parameter 80e labeled “Traces/screen” sets the number of individual traces that can be plotted before a screen refresh at one time. The parameter 80f labeled “Initial trace” defines the trace, which corresponding to a horizontal sampling distance, at which to begin plotting.

The von Hann window section 82, the signal averaging section 84, and the scaling function section 86 each include several parameters associated with signal processing functionality, the details of which will be discussed more fully below. Under the von Hann window section 82, there are parameters 82a and 82b that are labeled “Initial freq.” and “Final freq.”, respectively. These parameters control the width of the windowing function that is convolved with the frequency domain signal data to mitigate the effects of Gibb's phenomena caused by discrete sampling of a continuous signal. Furthermore, there is an activatable button 83 labeled “HannWin” that generates a plot of the von Hann window as defined by the parameters 82a, 82b in the graph area 76.

Under the signal averaging section 84 there is a parameter 84a that sets the type of averaging function to be applied to the input signal. These can be subtract, smooth, and subtract and smooth, though any other type may be substituted. The parameter 84b labeled “Aver. coeff.” specifies the value of the weighting coefficient applied to the surrounding data values during the calculation of the weighting function to be applied to the time domain input signal. The details of this function and parameters will also be discussed more fully below. An activatable button 85 labeled “Average” is operative to generate a plot showing the shape of the weighting function as defined by the parameters 84a and 84b.

Under the scaling function section 86, there is a parameter 86a labeled “Scale coeff.” that determines the amount that the initial, transmitted portion of a time domain signal is suppressed in order to enhance the weaker reflected target signals. The parameter 86b labeled “Scale time” defines the length of time the scaling function is applied to the time domain input signal. Further details concerning the scaling functionality are described below. An activatable button 87 labeled “Scale” is operative to generate a plot of the scaling function as defined by the parameters 86a and 86b in the graph area 76.

With reference to the block diagram of FIG. 1, once the foregoing parameters are set, the controller application 73 may then direct the vector network analyzer 14 to transmit and receive the interrogation signals. The controller application 73 may also initialize an array to hold a series of frequency data signal measurements or traces that are collected by the network analyzer 14.

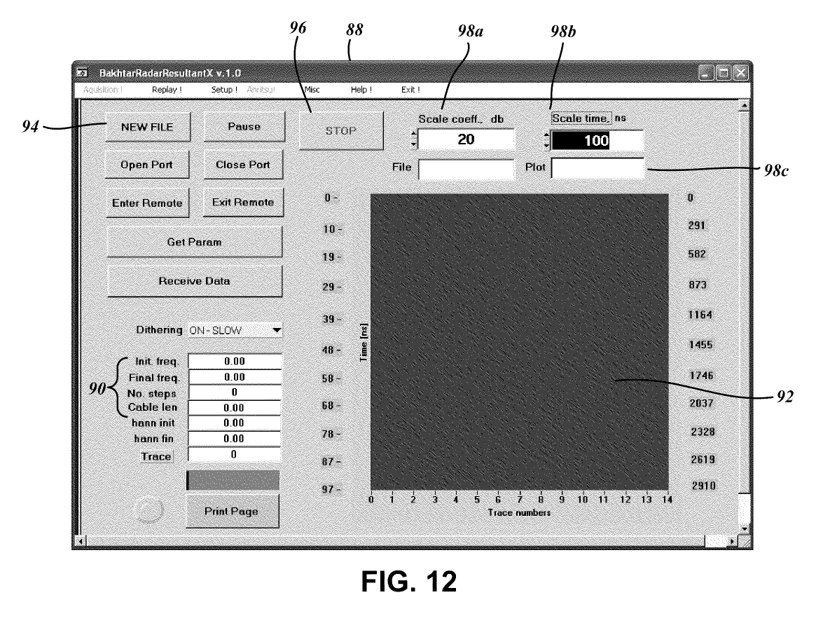

Further user-based control of this acquiring, storing, and displaying the interrogation signal is possible through an acquisition window 88, an exemplary one as generated by the controller application 73 being shown in FIG. 12. The signal sampling and processing parameters that were previously set in the setup window 74 are displayed again in the acquisition window 88. Specifically, the sampling parameters section 90 shows the initial and final frequency values for the sweep, as well as the number of frequency steps. In general, the acquisition window 88 is contemplated to generate the initial display of the interrogation signal after acquiring the same from the vector network analyzer 14.

As an initial step, a new interrogation may be initialized by selecting a new file button 94 to create the necessary job files that are stored on the interrogation data processing unit 16. The raw interrogation signal acquired by the vector network analyzer 14 generally does not display or highlight the desired targets in optimal form because of factors such as strong transmitted versus weak reflected target signals, signal noise, and narrow target frequency, so additional processing is employed. These processing functions include migrations, convolutions, and matched filtration, which will be considered in more detail below. Further, because of the difficulty in ascertaining, in advance, what processing will be needed, and at what values the processing and display parameters need to be set, complete signal processing and display is postponed until the interrogation is completed. As such, the acquired data is stored for later use. The files in which the acquired data is stored may be structured in a variety of different ways. There may be included headers with such information as sampling bandwidth, number of traces, frequency coverage, power output, and so forth.

The interrogation is started upon selecting a start/stop button 96 for a first time, and stopped upon selecting the start/stop button 96 for a second time. Once started, the controller application 73 retrieves the signal sampling parameters and transmits the same to the vector network analyzer 14 via the GPIB. In accordance with one embodiment, the controller application 73 interfaces with a device driver 100 that provides the low-level communications functions specific to the vector network analyzer. The device driver 100 may be part of the LabWindows development system mentioned above, and includes routines for initialization, configuration, parameter download and device activation/deactivation.

In accordance with an embodiment of the interrogation system 10, the data corresponding to the detected interrogation signal received from the vector network analyzer 14 is displayed in the plot area 92 in real-time. Prior to display, the plot area 92 is prepared to receive and correctly display the acquired data. Accordingly, any previously displayed data is cleared, and the axes are cleared to match the current signal acquisition parameters. Along these lines, the temporary buffers in which the data is to be stored are cleared, and the communications between the vector network analyzer 14 and the interrogation data processing unit 14 are verified.

As the data is received from the vector network analyzer 14, it is stored in a file. It is understood that there are 202 data points per sample, and is in a complex frequency domain format with real magnitude terms and complex phase terms represented by a, b, and c where Y=b*2c+j(a*2c). The data is written in a binary format in blocks of 1280 bytes. While the frequency domain format is ideal for signal transmission and acquisition of target reflection data, the time domain format is more suitable for target location and identification, particularly with a plot of the real magnitude in the time domain.

Referring again to the flowchart of FIG. 4, the method thus continues with a step 304 of transforming the first set of discrete measurements, that is, the data from the vector network analyzer 14, into a time domain format. Specifically, an inverse fast Fourier transform function is utilized to convert the a, b, and c triplets to complex frequency numbers given its equivalence to Y, above. The inverse fast Fourier transform is defined as:

$$x [ i ] = \frac{1}{n} {\sum }_{k = 0}^{n - 1} Y [ k ] {e}^{j 2 π ik / n} for i = 0 , 1 , … n - 1$$

where n is the number of data points, and x[i] is the inverse fast Fourier transform (FFT) of the frequency domain complex number Y[k].

The method for interrogating the target then proceeds to a step 306 of generating first traces of the time domain format data, which describes the signal travel time. Generally, the first traces are understood to correspond to a representation of the target and the test bed. A set of complex values are generated by the FFT function that correspond to the first sets of discrete measurements described above.

The traces are the real parts of the complex values, and can be displayed in real time in the plot area 92 of the acquisition window 88 in accordance with a step 308. The interrogation data processing unit 16 is thus understood to include a visualization submodule 102 that functions with or is a part of the controller application 73 that provides such functionality to generate the visual plot of the test bed and target. The settings for plotting the time domain format data or traces in the plot area 92 are defined by parameters 98a and 98b, which are the scale coefficient and the scale time, respectively. Additionally, the display time and traces per screen parameters provided in the setup window 74 define the plot range.

The plot may be in color, in grayscale, threshold, or in a “wiggle” format, the selection of which may be made through a parameter 98c labeled “Plot.” Plots in color or grayscale are envisioned to enhance the detection of targets having uncertain geometry and/or depth/distance over wiggle plots, (the plot of sinusoidal wave forms that represent the traces of a signal). Slight changes in magnitude due to weak target reflection may be difficult to discern in wiggle plots as well. In order to generate the color plots, a color map is used. The signal magnitude at each data point is assigned a unique color value, and is based upon a numerical combination of red, green, and blue values ranging from 0 to 255. The intensity of the signal defines the color map; blue colors represent lower intensities, red colors represent higher intensities, and black colors represent the highest intensity signals. A continuous plot is generated by interpolating colors between actual data points. Similar to color plots, grayscale plots map particular signal intensities to different grayscale levels.

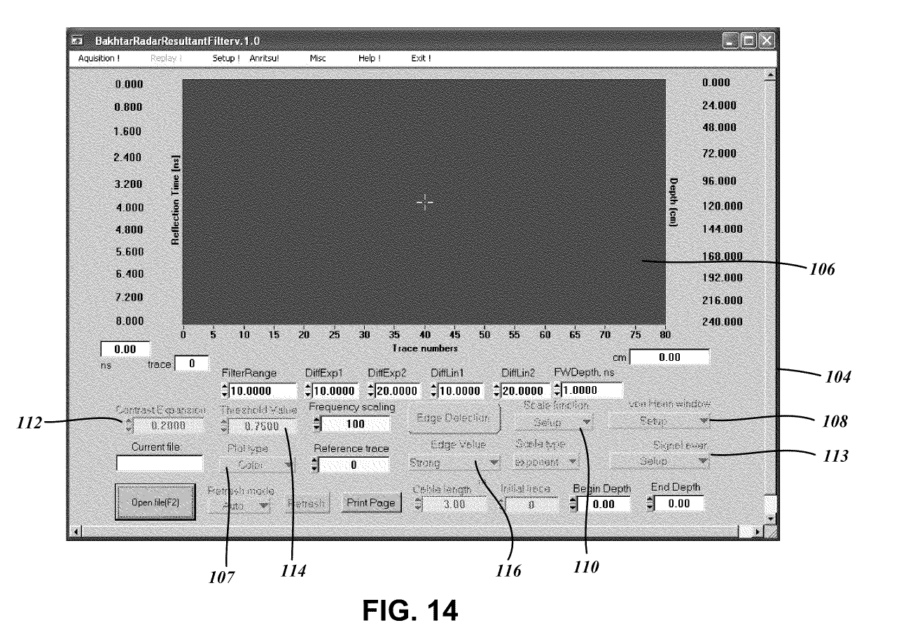

The resultant first traces from the inverse FFT function, which are in the time domain format, without further processing, generally does not indicate target location and definition adequately due to a number of different reasons previously noted such as signal noise. After acquisition, it is possible to manipulate the interrogation signal data to enhance or suppress certain characteristics, selectively plot signal magnitude ranges, reduce signal noise, and mitigate the effects of representing a continuous signal with discrete sample data. Thus, in addition to the acquisition window 88 that provides basic visualization function, a replay window 104 as shown in FIG. 14 provides a further sophisticated interactive visualization environment. From the replay window 104, the user can process interrogation data with different techniques to observe the different effects in signal display and target definition.

The replay window 104 includes a plot area 106 for viewing the processed signal data. All of the display functionality associated with the plot area 92 ad the acquisition window 88 are duplicated in the replay window 104, including the display of time domain signal data as an image of signal travel time versus trace number. The different plot types are also available, including color, grayscale, and wiggle, which are selectable via a plot pull down menu 107. The manner in which these different plot types are generated are the same as described above, and can be used for the same reasons.

Further processing of the interrogation signal can take place at different points in the method for interrogating the target embedded in the test bed. One such point is after sampling the scattered RF signal and before transforming the first sets of discrete measurements into the time domain format. Referring again to the flowchart of FIG. 4, there is contemplated a step 303 of applying a windowing function to the first sets of discrete measurements. This is understood to be performed by a filtering submodule 103 cooperating with the controller application 73. The windowing function is understood to extract a subset of the multiple sets of measurements over time.

When a continuous frequency domain signal is represented by a finite number of data samples, the sampling is akin to the convolution of a rectangular-shaped window with the continuous signal. The frequencies within the sampling interval are captured, but the frequencies between the sampling may be lost. As such, the continuous frequency signal function is represented by a discrete number of samples that are truncated at the edges. More particularly, this means that the FFT transformations are abruptly truncated. These truncations lead to large ripples or ringing about the discontinuities known as Gibb's phenomena that are caused by forced convergences of the truncated Fourier series. The discrete Fourier transform of a rectangular window w[n] is 1 if n is greater than or equal to zero or less than or equal to N−1, or is 0 otherwise, where N is the total number of elements in the signal array and n is the element of interest. More generally, the discrete Fourier transform is represented by a function:

$$W ( {e}^{j ω} ) = {e}^{- j ( N - 1 ) / 2 ω} \frac{sin ( \frac{N ω}{2} )}{sin ( \frac{ω}{2} )}$$

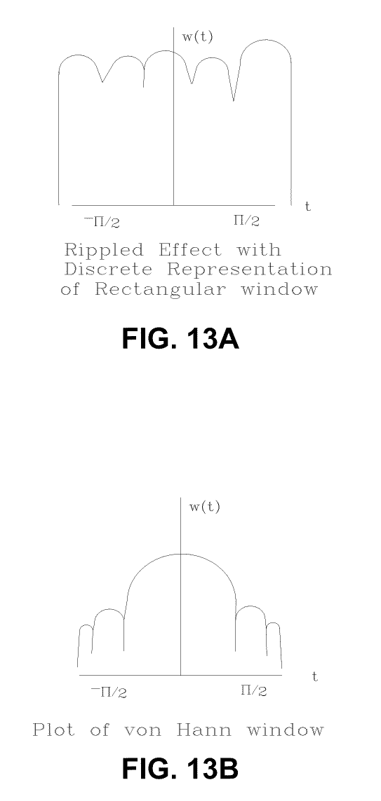

When this function is convolved with the continuous signal function, the resulting function exhibits large ripples both inside and outside the edges of the window at any points of discontinuity in the function, as shown in the plot of FIG. 13A.

One contemplated technique of reducing the ringing about the discontinuity is tapering off the window sampling shape to zero at both ends instead of an abrupt truncation with a rectangular shape. This may be achieved by the step 303 of applying the windowing function, which in accordance with one embodiment is a von Hann window shown in FIG. 13B, and defined per the following:

$$w [ n ] = \frac{1}{2} ( 1 + cos ( \frac{2 π n}{2 N} )$$

There are certain trade-offs involving frequency representation errors at the edge of a shallow taper, as well as large ripples due to a steep window. However, it is believed that the von Hann window provides an acceptable frequency representation at the sample edges while minimizing ringing. As shown in FIG. 13B, there are some losses associated with the main or central lobe, and significant reduction of the large side lobes. The von Hann window function can be utilized as a high pass, low pass, or band pass filter by selecting the frequency range of signal data points to include inside of the window. The selectable choices from a control button 108 include strong low pass, low pass, band pass, high pass, and strong high pass.

Yet another point in the method for interrogating the target embedded in the test bed at which the interrogation signal may be processed is immediately following the transformation step 304. The directly coupled signal between the transmit and receive antenna elements 12a, 12b located on the surface of the test bed is understood to be much larger in magnitude than the reflected signals from the subsurface targets. When the time domain representation of detected signals are plotted, the transmit signal tends to overpower the reflected signal. One contemplated technique involves scaling down the magnitude of the directly transmitted signal per step 311.

As will be appreciated, the transmitted signal is received earlier than the reflected signal because travel time is a function of distance or depth travelled. The transmitted signal is identified as being at the beginning of the signal data, and scaling down the magnitude of that beginning portion will result in the later detected, hence reflected, signal to appear to have a greater magnitude. The enhancement of the reflected portions of the signal is intended to improve target location and identification.

The degree and rate at which the scaling function is applied can be adjustable, that is, the scaling effect can be tapered from initial total suppression to no suppression at a later time. More than one function is contemplated because the relative strength and duration of the transmitted portion to the subsurface reflection differs between signals. In particular, each test bed is understood to have different attenuation, target depth/distance, and composition. For relatively shallow targets or targets composed of metal, the reflected signal may be stronger or be returned earlier, so an exponential scaling function is contemplated: e^{[0.115129}*db*(position in array/scaling length)]. Here, db sets the strength of scaling, and the scaling length is given in terms of nanoseconds. When multiplied by the input signal, tapering occurs rapidly, and the reduction factor rapidly approaches none from full suppression. For targets buried under significant depth, in attenuating test beds or test beds with poor reflective composition, the reflected signal may be returned later and may be substantially weaker. In this case, an exponential scaling factor is understood to be improper because some of the transmitted signals of greater magnitude will pass and overpower the weaker reflected target signals. Accordingly, a scaling method that provides a longer, more shallowly tapering suppression is appropriate, and a linear function of the quotient of the incremental position in scaling length divided by the scaling length is selected.

With reference to the example setup window 74 shown in FIG. 11, a parameter 86h labeled “Scale type” sets the particular scaling function that is to be applied. Among the choices for the scale type parameter includes short weak, short strong, long weak, and long strong, which refers to the scaling duration and strength, respectively for the exponential function. Where a linear function is selected, scaling is dependent on the duration. The parameters 86a and 86b can also be set to define the scale coefficient and the scale time, respectively. Selection of the scale type parameter is also possible through the replay window 104, which includes a similarly functioning drop-down menu/button 110.

When the detected interrogation signal contains isolated data points that are different in magnitude from its surroundings, the plotted time domain format data may appear cluttered, and targets and trends are difficult to discern. This effect may be mitigated by multiplying the measurement data by a function that averages the isolated data points to more closely match the surroundings according to a step 313. A smoothing technique, as well as a subtracting technique, is contemplated. Smoothing replaces the original data value d(n) with an average of the original value and the sum of the surrounding values weighted according to distance. It may be defined as follows:

ds(n)=norm(d(n)+(a*d(n−1)+a*d(n+1)+a*a*d(n−2)+a*a*d(n+2)+ . . . ))

where a is a weighting coefficient between zero and one. Subtracting replaces the original value with an average of the difference between the original value and the average of the surrounding weighted values. An average signal value is subtracted from the original value, and may be defined as follows:

ds(t)=norm((d(n)−norm(a*d(n−1)+a*d(n+d(n+1)+a*a*d(n−2)+a*a*d(n+2)+ . . . )))

In the replay window 104, the selection of the averaging function is made via a drop-down menu control/button 110 that is operative to show a list of the aforementioned variations of the same. These include strong smooth, smooth, weak smooth, subtract, and subtract and smooth. Strong or weak refers to the value of the weighting coefficient, with the strong type having a higher value. These values can also be set through the parameters 84a, 84b in the setup window 74.

After generating the first traces of the time domain format data per step 306, various steps to enhance the visualization of the plots may be performed. In further detail, the relative strength of the target reflection signals may be dependent on depth/distance from the forced resonating antenna unit 123, the target material and the test bed characteristics. With a non-metal target embedded at great depth or distance, or surrounded in a signal-attenuating test bed, there may be a weak reflected signal. As a result, the target may not be easily discernible in a time domain plot. The range of variation of the target signal magnitude is much smaller than the total magnitude range available. Thus, visibility of the targets may be improved by expanding that range, or the contrast of the plot in accordance with a step 315, so that the values of the desired magnitudes cover the entire available range. It is contemplated that the mapping or expansion of the contrast range is linear and is one-to-one.

With a color plot such as the one discussed above, the smallest magnitudes in the original desired range of the signal are assigned background colors such as cyan, while the largest magnitudes are assigned the strongest colors such as black. Intermediate values in the original signal may be given new values that are linearly interpolated to colors between cyan and black, for example.

Similar contrast expansion techniques can be applied to gray scale plots where the smallest values in the desired range are assigned to be black, while the largest values in the desired range are assigned to be white. Intermediate values in the original signal may be given new values that are linearly interpolated to shades of gray.

Contrast expansion is implemented for visualizations on the replay window 104, and specifically those that are generated in the plot area 106 thereof. The expansion or magnification of the contrast range is based upon coefficients that are specified via an input control 112. As indicated above, the relative strength of the reflected target signal is dependent on the target material and the test bed composition, each interrogation may warrant a different coefficient value. The value can range between 0.0 and 1.0; the smaller the value, the greater expansion so that weaker magnitudes will be mapped over the contrast range. As the value approaches 1, the less the contrast range is expanded.

Referring again to the flowchart of FIG. 4, the method includes the step 308 of displaying the plot of the first traces. Among the display options available from the acquisition window 88 include color plots, grayscale plots, and wiggle plots. With the entirety of the interrogation data available, an additional plot type that increases visibility of the targets and assist in discerning those targets from noise is contemplated in accordance with various embodiments of the present disclosure. With threshold plots, signals having an intensity higher than a cutoff intensity or a threshold value are shown in white, while signals having an intensity lower than the threshold value are shown in black. By adjusting the threshold value, detected targets can be discriminated against noise.

With threshold plots, one type of target object is detected based upon signal magnitude and others are discarded. One envisioned application for threshold plots is the detection of buried non-native targets because the material composition thereof, and hence any reflected signals, is different from the surrounding test bed. Referring to the example replay window 104 of FIG. 14, an input control 114 is receptive to a threshold value between 0.0 and 1.0. It is understood that the threshold magnitude is dependent on the target and the test bed, so each interrogation may warrant a different value. A smaller value is understood to allow a weaker magnitude to be mapped above the threshold, while a value closer to 1 will significantly restrict the extent the foreground signal is shown.

The foregoing techniques of signal and image enhancement, including windowing, scaling, and contrast expansion, assist in discerning the target location. However, without additional processing, the geometry (i.e., the shape and size) of the target may be difficult to determine because color, grayscale, ad trace plots are constructed to show detail and fine signal gradations. Such details are understood to be useful for locating the target, but may also mask the actual edges of the target. Target edges, in turn, determine target geometry, and target geometry assists in target identification.

Target edge detection is generally understood to involve the identification of abrupt changes in magnitude or the rate of change in magnitude. For non-binary images (i.e., grayscale), a differencing or gradient calculation is made between each discrete data point and surrounding data points. The difference is compared against predefined values, and contiguous gradients above the designated threshold are plotted as edges in a binary image.

In order to perform this operation, the first traces of the discrete measurements are arranged in two dimensions, and are converted to this format from the set of traces in a vector that are otherwise utilized in generating the various plots considered above. The vector is mapped to a two-dimensional plot. In further detail, the traces are index row or trace number first, [j], followed by the column or position in the trace [i], and are input into the matrix row by row. Not only can this two-dimensional plot be utilized for edge detection, there is a wide variety of image processing algorithms that may be applied thereto for further enhancement. For example, high pass filters may be applied to the plot for sharpening image detail, median filters may be applied for despeckling purposes, and so forth.

According to one embodiment of the present disclosure, the edge detection method utilizes a Sobel operator, which is 3×3 matrix as follows:

$$[ \begin{matrix}1 & 2 & 1 \\ 0 & 0 & 0 \\ - 1 & - 2 & - 1\end{matrix} ] \times \frac{1}{8}$$

The Sobel operator is a non-linear matrix operator that is utilized in a discrete differencing scheme applied to an image where a large difference implies an edge location. Specifically, the differencing is applied in two orthogonal directions and combined to yield a magnitude result m independent of the orientation according to: m=\sqrt{μ²+v²} where u and v are the orthogonal differentials. As will be appreciated, m is independent of orientation. In further detail, the operator is convolved point by point with the input image data matrix in the orthogonal directions. The transpose of the image data matrix is understood to be the orthogonal matrix. The image data matrix to be convolved is represented as:

$$[ \begin{matrix}{Z}_{3} & {Z}_{2} & {Z}_{1} \\ {Z}_{4} & Z & {Z}_{0} \\ {Z}_{5} & {Z}_{6} & {Z}_{7}\end{matrix} ]$$

where Z, the center element, is the data point of interest, and the Z₁-Z₇ are the surrounding elements. The Sobel magnitude is calculated from u and v, where u=((Z₅+2 Z₆+Z₇)−(Z₁+2 Z₂+Z₃))×⅛ and v=((2Z₀+Z_{1+Z}₇)−(Z₃+2 Z₄+Z₅))×⅛.

After the convolving operation an edge value is chosen and contrast expansion is adjusted as discussed above. In particular, the gradient values are compared, and local maxima are checked. The magnitude m for each data point is compared with a cutoff value, and those larger than the cutoff value and also greater than the surrounding gradients in orthogonal directions are stored in a plotting matrix. The positions in this plotting matrix corresponding to values that do not meet this criteria are given a value of zero. The plotting matrix values are then mapped to a plot routine according to a criteria defined by the edge value strength, which is adjustable through an input control 116 in the replay window 104. A plot is then created by mapping gradient values to white if the edge value criteria are satisfied, and otherwise to black. Selecting the weak option results in mapping a lower gradient magnitude to white, while selecting the strong option results in a mapping a higher gradient magnitude to white.

Referring again to the block diagram of FIG. 1, the interrogation data processing unit 16 includes a discriminator filter submodule 118 that cooperates with the visualization module 102 and the controller application 73 for real-time target detection based upon an averaged magnitude of the signal intensity for a specific target in a test bed. It is contemplated that this filtering modality enhances target separation from noise, and is applied to the time domain format data described above.

In further detail, the method begins with finding the maximum signal intensity for all traces in a screen. Thereafter, the depth where the maximum signal intensity occurs is determined; the maximum signal intensity is presumptively where the target or noise is located. A two nanosecond window that encompasses one nanosecond above and one nanosecond below the maximum signal intensity is determined. The average signal intensity over a single trace for the two nanosecond window is calculated, and repeated for each of the traces of the screen. The maximum values of all of the average signal intensities over the traces is calculated, and an average value thereof is calculated. The difference between the average and the maximum is calculated; if the difference is greater than set threshold values, then a target has been detected, otherwise, noise has been detected. To the extent that noise is detected, the signal values for those traces are set to zero to maintain a blank screen. To the extent that targets are detected, the corresponding maximum value is compared with subsequent and previous maximum values. If the difference is within a predefined filter range, it is determined to be part of the target and hence displayed. Otherwise, the screen remains blank.

More generally, the aforementioned statistical averaging filter specifying a range DiffExp1-DiffExp2, both of which are set in the replay window 104 and is associated with exponential scaling, as well as a range DiffLin1-DiffLin2, both of which are also set in the replay window 104 and is associated with linear scaling. If the signal intensity falls within these ranges, then it is displayed.

In addition to the two-dimensional plots described above, various embodiments of the present disclosure also contemplate a volumetric reconstruction of a potential target. The signal magnitude information from the two-dimensional cross section plots, in combination with the discriminator filter module 118, can be utilized to effectively identify a target. A two-dimensional cross section may be inadequate if the target has an irregular shape, or skewed relative to the plane of the forced resonating antenna unit 12. In such a case, additional images of the target may need to be acquired at different orientations for proper identification. Each two-dimensional plot may be combined together to reconstruct a volumetric representation, such that the true dimensions and position of the target is shown.

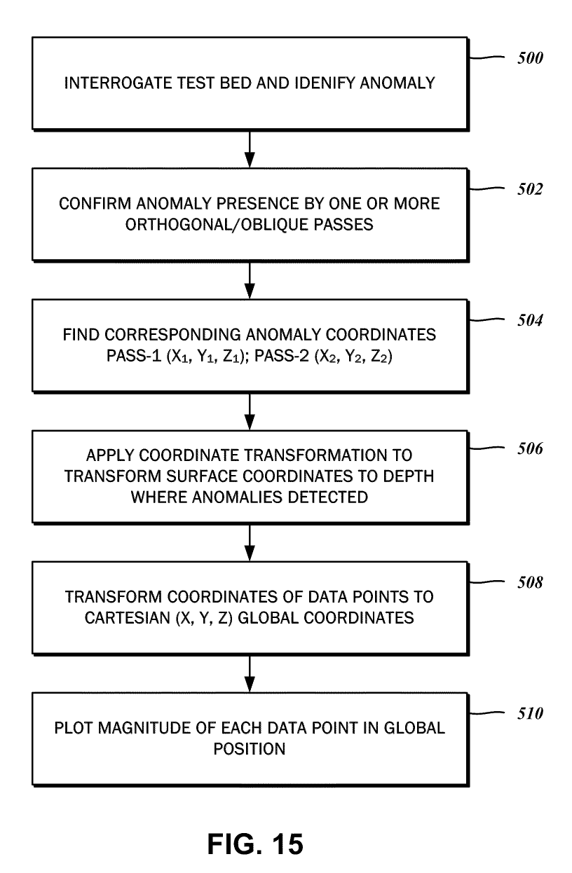

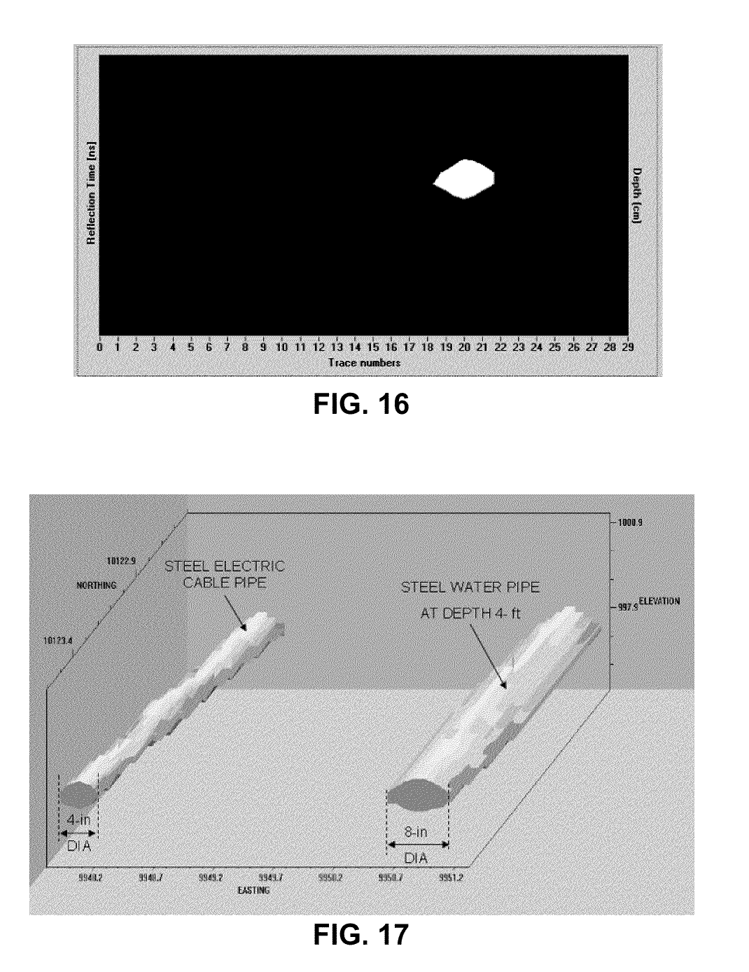

With reference to the flowchart of FIG. 15, the method begins with a step 500 of interrogating the test bed and identifying an anomaly. FIG. 16 illustrates an exemplary two-dimensional plot displayed in a threshold format. This is understood to correspond to the two-dimensional plotting of the interrogation discussed above. Thereafter, in step 502, presence of the anomaly is confirmed with one or more orthogonal or oblique passes along the test bed. The coordinates for the magnitude data points in each two-dimensional views are located per step 504 and transformed surface coordinates to the depth where the anomalies are detected in accordance with step 506. Thereafter, the coordinates of data points are transformed to three-dimensional global coordinates in step 508, and each magnitude is plotted in its global position in step 510. As shown in FIG. 17, a composite of these points is the volumetric plot of the signal magnitudes for the targets of interest.

Determination and transformation of the coordinates for each data point is based on the central-projection imaging equation:

$$[ \begin{matrix}p \\ q \\ 1\end{matrix} ] = [ \begin{matrix}{m}_{11} & {m}_{12} & {m}_{13} & 0 \\ {m}_{21} & {m}_{22} & {m}_{23} & 0 \\ {m}_{31} & {m}_{32} & {m}_{33} & 0\end{matrix} ] [ \begin{matrix}1 & 0 & 0 & - {x}_{R} \\ 0 & 1 & 0 & - {y}_{R} \\ 0 & 0 & 1 & - {z}_{R} \\ 0 & 0 & 0 & 1\end{matrix} ] [ \begin{matrix}x \\ y \\ z \\ 1\end{matrix} ] [ \begin{matrix}\frac{1}{f} & 0 & \frac{- {p}_{0}}{f} \\ 0 & \frac{1}{f} & \frac{- {q}_{0}}{f} \\ 0 & 0 & 1\end{matrix} ] λ$$

where ƒ is the camera focal length, −p₀ and −q₀ are coordinates where the optical axis pierces the image plane in image plane coordinates, p and q are the image plane coordinates of the target, and mᵢⱼ represent the elements of the rotation matrix that describes camera orientation in the global coordinate system. Additionally, the R subscripted coordinates represent the coordinates of the projection center of the camera in the global coordinate system, and x, y, and z represent the global coordinates of the target.

With the controller application 37, a corresponding equation that relates the data point coordinates in the two dimensional image to the volumetric test bed coordinates for the target can be written. In consideration of the most general case where the test coordinates are only known for a single reference point xₒ, yₒ, zₒ it is as follows:

$$[ \begin{matrix}test - bed wave speed & 0 & - elev . w / r to GPS 0 \\ 0 & platform speed & - horiz . dist . w / r to GPS 0 \\ 0 & 0 & 1\end{matrix} ] [ \begin{matrix}time ( ns ) \\ dist . ( trace ) \\ 1\end{matrix} ] = [ \begin{matrix}{l}_{1} & {m}_{1} & {n}_{1} & 0 \\ {l}_{2} & {m}_{2} & {n}_{2} & 0 \\ {l}_{3} & {m}_{3} & {n}_{3} & 0\end{matrix} ] [ \begin{matrix}1 & 0 & 0 & - {x}_{R} \\ 0 & 1 & 0 & - {y}_{R} \\ 0 & 0 & 1 & - {z}_{R} \\ 0 & 0 & 0 & 1\end{matrix} ] [ \begin{matrix}x \\ y \\ z \\ 1\end{matrix} ]$$

where: lᵢ, mᵢ, and nᵢ represent direction cosines between global coordinate axes and image coordinate axes. In further detail, Test-bed wave speed is the vertical speed of TEM wave in test bed, antenna speed is the horizontal speed of the moving platform towing the antenna, elev. w/r to GPS0 is the difference in antenna elevation with respect to the reference point, time is the vertical time travel of the TEM wave, and trace is the trace number. Furthermore, R-subscripted coordinates are the global coordinates of the forced resonating antenna unit 12, and ( )-subscripted coordinates are global coordinates of the reference point.

The time and trace coordinates can be processed directly from the interrogation system 10. The setup parameter values of initial and final frequencies, number of sample traces and number of samples per trace, along with a vector of time domain signal magnitudes comprise the needed information. The horizontal trace distance (trace) is calculated from the time domain magnitude vector:

$$( \frac{vector position}{no . samples per trace} ) - RoundToNearestInteger ( \frac{vector position}{total no . traces} ) ) ⋆ size of vector .$$

If the quantity is less than 0.5, the trace number is:

$$RoundToNearestInteger ( \frac{vector position}{no . samples per trace} ) + 1$$

otherwise, the trace number is:

$$RoundToNearestInteger ( \frac{vector position}{no . samples per trace} )$$

The vertical time position (ns) is also calculated from the time domain magnitude vector as follows. First, the ambiguity time is calculated, which is a constant for each image:

$$tt = \frac{time}{trace} = \frac{1}{\frac{start frequency - stop frequency}{frequency vector size - 1}}$$

Second the time for each sample is calculated. This is also constant for each image:

$$sample time = \frac{tt}{2 ⋆ time vector size}$$

Third, the position in the trace is calculated:

$$position = ( \begin{matrix}\frac{vector position}{no . samples per trace} - \\ RoundToNearestInteger ( \frac{vector position}{total no . per traces} )\end{matrix} ) ⋆ size of time vector .$$

Fourth, the vertical time position of the sample is calculated:

vertical position=time=vertical location in image matrix*sample time

The equation above that relates image and global coordinates cannot be solved in its present form. Solving for the global coordinates requires inversion of a 3×4 matrix composed of the image coordinate rotation matrix multiplied by the image coordinate translation matrix. Since the matrix is not square, the operation cannot be performed. If the global R-subscripted coordinates of the image are separately combined with the rotation matrix, this problem is resolved. This allows elimination of the augmented portions of the rotation and translation matrices and the coordinate matrix. The equation will then be:

$$\begin{matrix}[ \begin{matrix}test - bed wave speed & 0 & - elev . w / r to GPS 0 \\ 0 & platform speed & - horiz . dist . w / r to GPS 0 \\ 0 & 0 & 1\end{matrix} ] & [ \begin{matrix}time ( ns ) \\ dist . ( trace ) \\ 1\end{matrix} ] & = & ( & [ \begin{matrix}{l}_{1} & {m}_{1} & {n}_{1} \\ {l}_{2} & {m}_{2} & {n}_{2} \\ {l}_{3} & {m}_{3} & {n}_{3}\end{matrix} ] & [ \begin{matrix}x \\ y \\ z\end{matrix} ] & - & [ \begin{matrix}{l}_{1} & {m}_{1} & {n}_{1} \\ {l}_{2} & {m}_{2} & {n}_{2} \\ {l}_{3} & {m}_{3} & {n}_{3}\end{matrix} ] & [ \begin{matrix}{x}_{R} \\ {y}_{R} \\ {z}_{R}\end{matrix} ] & ) \\ S & x & = & ( & C & X & - & C & R & )\end{matrix}$$

In this form, the 3×3 matrix, C, is square and invertible, and the resultant vector CR can be added to the vector Sx, allowing solution of the vector of global coordinates, X:

CR+S x=CX

C⁻¹(CR+S x)=X

More accurate target locations could be made if the coordinates and spatial orientation of the forced resonating antenna unit 12 are known at the time each radar trace was taken. The antenna orientation would determine the path of the radar trace, which could be projected onto the test bed to calculate a target location with respect to the antenna surface coordinates. The point coordinate equation above would reduce to:

$$[ \begin{matrix}test - bed wave speed & 0 & 0 \\ 0 & 0 & 0 \\ 0 & 0 & 0\end{matrix} ] [ \begin{matrix}time \\ 0 \\ 0\end{matrix} ] = ( \begin{matrix}[ \begin{matrix}{l}_{1} & {m}_{1} & {n}_{1} \\ {l}_{2} & {m}_{2} & {n}_{2} \\ {l}_{3} & {m}_{3} & {n}_{3}\end{matrix} ] [ \begin{matrix}x \\ y \\ z\end{matrix} ] - \\ [ \begin{matrix}{l}_{1} & {m}_{1} & {n}_{1} \\ {l}_{2} & {m}_{2} & {n}_{2} \\ {l}_{3} & {m}_{3} & {n}_{3}\end{matrix} ] [ \begin{matrix}{x}_{R} \\ {y}_{R} \\ {z}_{R}\end{matrix} ]\end{matrix} )$$

Using the matrix solving procedures described above, coordinate calculation begins with a first step of setting up a global coordinate system for volume reconstruction. This involves setting a point on the test bed where the location can reference all needed signal data points. The global coordinate system is understood to cover the entire volume of interest.

Then, a second step of acquiring surface coordinates of the forced resonating antenna unit 12 simultaneously with each trace is performed. Surface coordinates may be obtained with a Novatel GPS for outdoor interrogation of large test beds and a laser unit for indoor interrogation of a small test bed, and are stored in a Microflex data collector using Carlson GPS and survey software. The GPS receiving antenna and laser marker are mounted on top of the forced resonating antenna unit 12 as indicated above. The requirement of simultaneous surface coordinates and trace data is met by integrating the GPS or laser triggering with the triggering module 18. A serial cable is connected between the data collector and the interrogation data processing unit 16. The Carlson software for GPS and corresponding software for laser system are modified to send a character from the data collector over the serial line to the interrogation data processing unit 16 at the instant that a GPS or the laser coordinate measurement is made. The controller application 73 triggers trace data collection when a character is detected at the serial port.

The method then continues with a third step of importing surface coordinate files into the controller application 73, and selecting the parts that contain the locations above suspected targets. Surface coordinate and signal magnitude data files are prepared for use in the subsurface coordinate calculation. More particularly, the surface coordinate files from the Microflex or the new Carlson data collector are downloaded in ASCII text format via the serial connection to the interrogation data processing unit 16. Suspected targets to be imaged volumetrically are identified by examining the signal magnitude data in the replay window 104, and traces covering the target area are noted. The surface coordinate file is formatted for subsurface coordinate calculation. The range of the surface coordinate file corresponding to the suspected target area is specified by the user or extracted from the file. General signal information and magnitude for each data point is saved in ASCII text files, which can be read into the subsurface coordinate calculation program. The magnitude values from a signal acquisition will be placed in a vector. Parameters for subsurface coordinate and signal magnitude calculation are input.

Next, subsurface coordinate calculation is performed. This involves first calculating a local orientation of the signal data points. The points in the signal data vector can be referenced to a vector x, which is composed of the trace and index in the trace, by means of total traces and total signal travel time. Each trace and index in the trace can then be related to a 2-dimensional, i.e., horizontal and vertical, position in the local view. A transformation matrix S, maps the trace and time index to the spatial coordinates. Second, the orientation is transformed to a global coordinate system. The local coordinates of the data points are transformed to three-dimensional global coordinates, X, via the transformation matrix, C, which represents the orientation of the signal view, and global reference points, R that mark the location of the antenna during signal acquisition. Third, the calculated subsurface three-dimensional coordinates for each data point is assembled together with its magnitude data, and saved in an ASCII text output file on a point-by-point basis.

A solid four-dimensional model is generated from the coordinates and signal magnitudes of discrete data points acquired by the receiving forced-resonating antenna element 12a. In particular, visualization software such as the Rockwell plotting package accepts the coordinate/magnitude data in the ASCII text format and can create a model directly from irregularly distributed three dimensional data points and enable forth dimension to be superimposed for better discrimination.

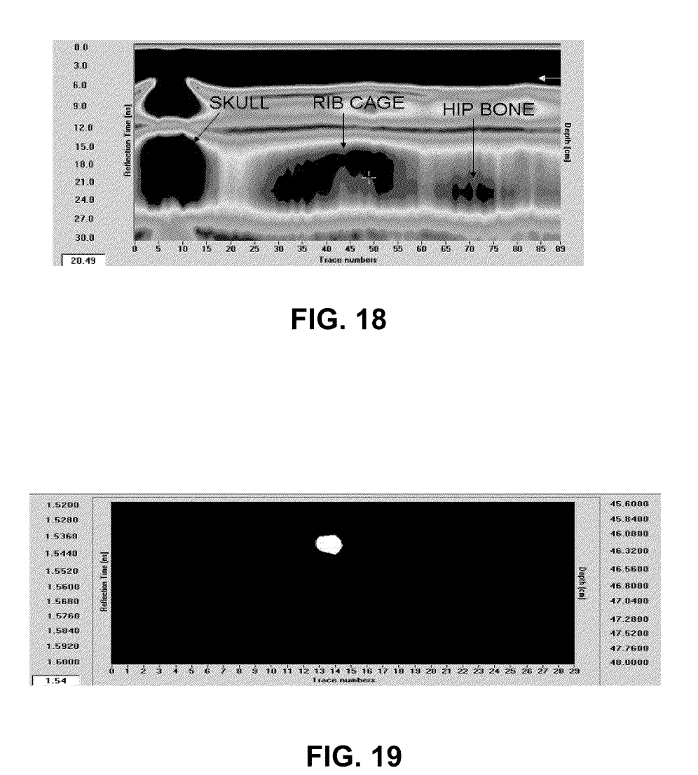

Having described the various embodiments of the interrogation system 10 and the method for interrogating the target embedded in the test bed, several experimental results that verify the disclosed functionality will now be considered. With particular reference to FIG. 18, the results of interrogating a 75 years old buried remains at a grave site using the forced resonating antenna unit 12. The tomographic image through the major axis of the body clearly reveals what is left after 75 years including the skull, partial rib-cage, and hip bones. These detections were maid in a moist, clay-rich test bed.

FIG. 19 is a threshold image of a radiology phantom interrogated with the forced resonating antenna unit 12. Specifically, the Luc-Al Phantom utilized is composed of a clear acrylate-polymethyul-methacrylate with overall dimensions of 4.5 cm by 10 cm by 11 cm with small aluminum inserts. This two-component object is understood to match accurately the narrow beam attenuation of tissue thickness being simulated with good accuracy for all energies in diagnostic range. Phantoms provide consistent and clinically representative results and commonly used for calibrating X-ray machines before commissioning them for medical applications. The Phantom was used here to check attenuation characteristics of low-power (below 10 dBm) energy transmitted by the interrogation system 10. The high resolution shown is understood to be attributable to the forced-resonating energy and the internal processor sampling rate of 300 Hz in the frequency domain during data acquisition. The power output from the interrogation system 10 is maintained at below 10 milliwatts.

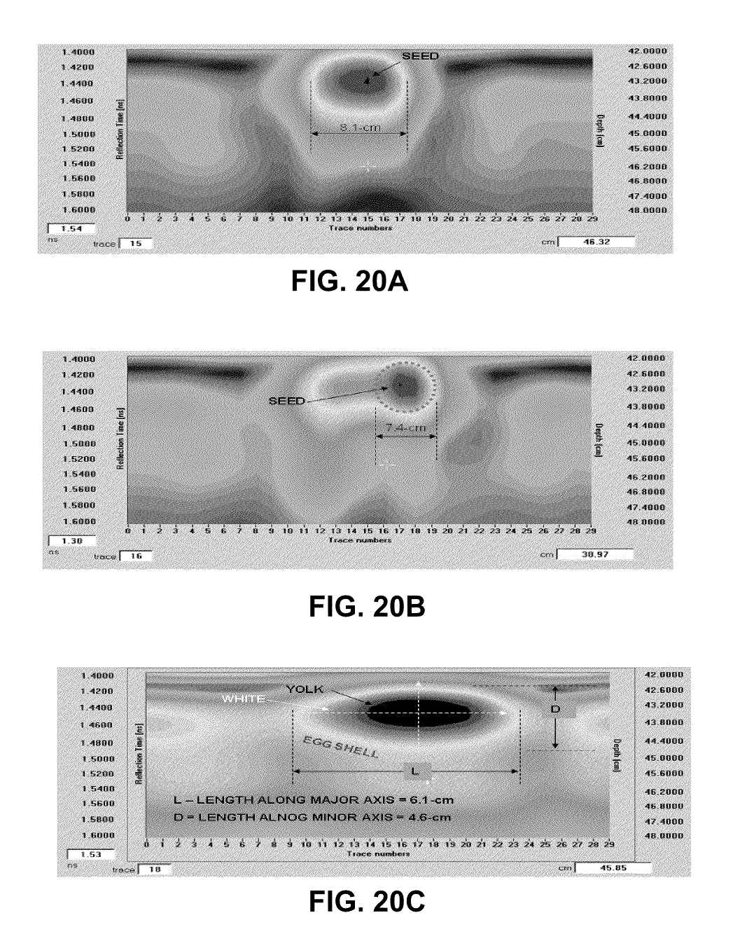

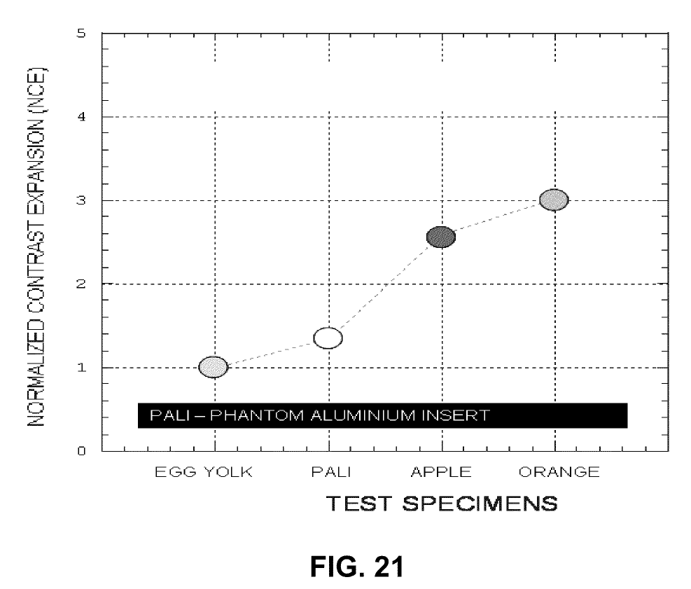

FIGS. 20A, 20B, and 20C show the computer tomography scans of an orange, an apple, and an egg, respectively, including its constituent parts. More particularly, FIG. 20A shows the inside of an orange including its seed, and FIG. 20B shows the inside of the apple with its seed. Furthermore, FIG. 20C shows the inside of the egg including its yolk, white, and shell. Each test object was placed on a small polyethylene plate and pulled at a constant slow speed under stationary antennas during the test procedure with an operating frequency band of 2400 MHz. Normalized results of tests conducted are shown in FIG. 21.

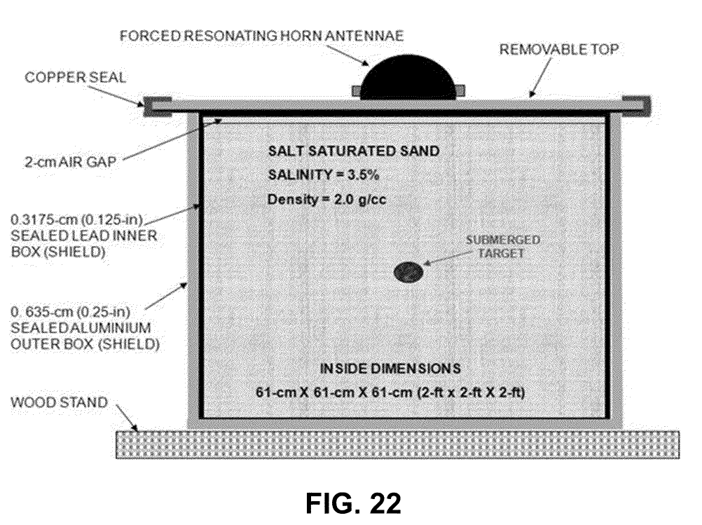

With reference to FIG. 22, there is illustrated an example test bed of a sealed, double shielded lead aluminum box that is filled with 3.5% salt saturated sand. The forced resonating antenna unit 12 is placed on the top surface of the box, and the contents are interrogated for various resistive and conductive targets placed in the center. This scenario is intended to demonstrate the capability of the interrogation system 10 to overcome Faraday's Cage and skin depth effects, and the contents of the box simulates the electromagnetic properties of the ocean to a 2 km depth. The interrogation system was operated at a bandwidth of 400 MHz under the reflection mode.

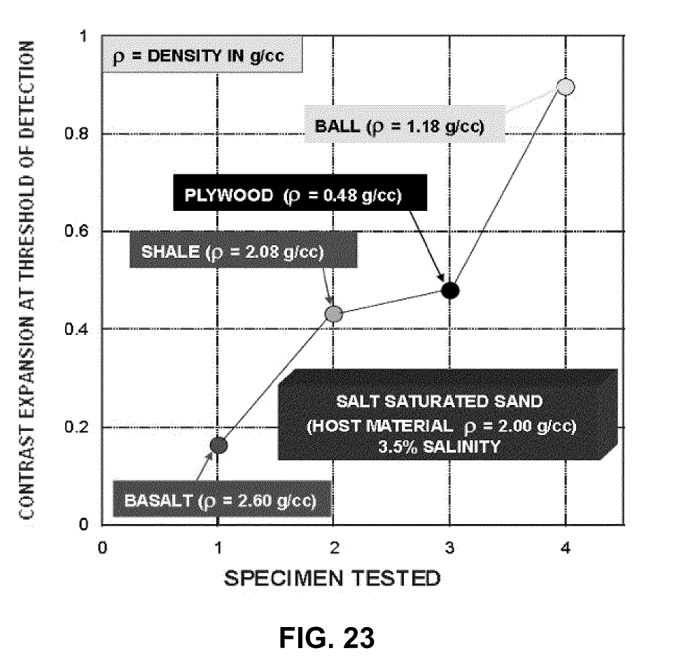

FIG. 23 shows variation of contrast expansion (CE) at the threshold of detection for the double shielded targets tested inside the lead box. The results presented show that the detection capabilities are based on intrinsic material properties and not from the density.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. An electromagnetic interrogation system for analyzing a target embedded in a test bed comprising:
a forced resonating antenna unit including a transmit element and a receive element mounted on a platform movable over the test bed;
an interrogation signal source generating a continuous stepped-frequency radio frequency (RF) signal and connected to the transmit element of the forced resonating antenna over a first transmission line;
a plurality of receiver channels connected to the receive element of the forced resonating antenna over a second transmission line, ratios of the scattered continuous stepped-frequency RF signal on a first one of the receiver channels and on a second one of the receiver channels each relative to a reference one of the receiver channels being derived as a measurement for each frequency step;
a triggering module linked to the receiver channels and generating a positional data value corresponding to a set of measurements for one or more stepped frequency sweeps; and
an analysis module for generating test bed analysis results based upon multiple sets of measurements over time and the corresponding positional data values received by the analysis module.

2. The system of claim 1, wherein the test bed is selected from a group consisting of:
a human body, a metallic container, earth subsurface, earth seabed, and an architectural structure.

3. The system of claim 1, wherein the triggering module is a Global Positioning Satellite (GPS) receiver connected to a GPS antenna.

4. The system of claim 3, wherein the GPS antenna is disposed on the forced resonating antenna unit.

5. The system of claim 1, wherein the triggering module is a laser distance measuring device.

6. The system of claim 1, wherein:
the transmit element of the forced resonating antenna unit is opposed to the receive element of the forced resonating antenna unit; and
the detected continuous stepped-frequency RF signal is a forward signal transmitted through the test bed.

7. The system of claim 1, wherein:
the transmit element of the forced resonating antenna unit is coplanar to the receive element of the forced resonating antenna unit;
the detected continuous stepped-frequency RF signal is a backscattered signal from the test bed.

8. The system of claim 1, wherein the analysis module includes a visualization sub-module generating a visual plot corresponding to the test bed analysis results.

9. The system of claim 8, wherein the visual plot is a two-dimensional representation of the test bed and the target.

10. The system of claim 8, wherein the visual plot is a volumetric representation of the test bed and the target.

11. The system of claim 8, wherein the analysis module includes a discriminator filter sub-module cooperating with the visualization sub-module to identify a section of the visual plot representative of the target.

12. The system of claim 1, wherein the analysis module includes a filtering sub-module, a subset of the multiple sets of measurements over time being extracted thereby for the test bed analysis based upon a windowing function.

13. The system of claim 12, wherein the windowing function is a von Hann window applied having a filter type selected from a group consisting of: strong low pass, low pass, strong high pass, high pass, and medium pass.

14. The system of claim 1, wherein the forced resonating antenna unit includes a pair of dipole antennas each corresponding to the respective one of the transmit element and the receive element.

15. The system of claim 1, wherein the forced resonating antenna unit includes a pair of horn antennas each corresponding to the respective one of the transmit element and the receive element.

16. The system of claim 1, wherein the interrogation signal source and the receiver channels are parts of a vector network analyzer device.

17. A method for interrogating a target embedded in a test bed comprising:
triggering the transmission of a continuous stepped-frequency RF signal to the test bed through a transmit forced resonating antenna traversing the test bed along a first axis;
directing the sampling of the scattered continuous stepped-frequency RF signal through a receive antenna as first sets of discrete measurements across a first axis of the test bed, the first sets of discrete measurements being in a frequency domain format represented as complex values including magnitude terms and phase terms;
transforming the first sets of discrete measurements from the frequency domain format to a time domain format;
generating first traces of real values of the first sets of discrete measurements in the time domain format from the corresponding complex values, the first traces corresponding to a cross-sectional representation of the target and the test bed.

18. The method of claim 17, further comprising:
applying a windowing function to the set of discrete measurements in the frequency domain to remove truncation edge effects therefrom.

19. The method of claim 17, wherein the transforming the first sets of discrete measurements includes applying an inverse fast Fourier transform (FFT) function to real and imaginary values of the first sets of discrete measurements in the frequency domain format.

20. The method of claim 17, further comprising:
applying a scaling function to the first sets of discrete measurements in the time domain format.

21. The method of claim 17, further comprising:
displaying a two-dimensional plot of the first traces visually representing the target and the test bed.

22. The method of claim 21, wherein the two-dimensional plot has a format selected from a group consisting of: color, wiggle, threshold and grayscale.

23. The method of claim 21, further comprising:
identifying a region on the two-dimensional plot corresponding to the target based upon the magnitudes of the first traces.

24. The method of claim 17, further comprising:
directing the sampling of the scattered continuous stepped-frequency RF signal as second sets of discrete measurements across a second axis of the test bed orthogonal to the first axis, the second sets of discrete measurements being in the frequency domain format represented as complex values;
transforming the second sets of discrete measurements from the frequency domain format to the time domain format;
generating second traces of real values of the second sets of discrete measurements in the time domain format from the corresponding complex values; and
generating a volumetric representation of the test bed and the target based upon the first traces and the second traces.

25. An article of manufacture comprising a program storage medium readable by a data processing apparatus, the medium tangibly embodying one or more programs of instructions executable by the data processing apparatus to perform a method for interrogating a target embedded in a test bed, the method comprising:
triggering the transmission of a continuous stepped-frequency RF signal to the test bed through a transmit forced resonating antenna traversing the test bed along a first axis;
directing the sampling of the scattered continuous stepped-frequency RF signal through a receive antenna as first sets of discrete measurements across a first axis of the test bed, the first sets of discrete measurements being in a frequency domain format represented as complex values including magnitude terms and phase terms;
transforming the first sets of discrete measurements from the frequency domain format to a time domain format;
generating first traces of real values of the first sets of discrete measurements in the time domain format from the corresponding complex values, the first traces corresponding to a proportionally scaled cross-sectional representation of the target and the test bed.

26. A method for tuning a forced resonating antenna utilized in the interrogation of a test bed for a target, the method comprising:
measuring the electromagnetic wave speed for the test bed;
deriving a fundamental complex frequency value with a magnitude component and a phase component based upon the measured electromagnetic wave speed for the test bed;
deriving a complex frequency spectrum for an operating range of the antenna from the derived fundamental complex frequency value;
forced resonating a prototype antenna circuit including an antenna element and resistance, capacitive reactance, and inductive reactance components with initial values corresponding to the complex frequency spectrum, the prototype antenna circuit being forced resonated at the fundamental complex frequency value, an odd harmonic of the fundamental complex frequency value, and an even harmonic of the fundamental complex frequency value;
balancing the prototype antenna circuit for a predefined impedance value; and
substituting each of the inductive reactance and capacitive reactance components of the prototype antenna circuit with resistive components while substantially matching the predefined impedance value;
wherein an optimized prototype antenna circuit is the tuned forced resonating antenna.

27. The method of claim 26, further comprising:
extending the length of the antenna for the substituted resistive components.

28. The method of claim 26, wherein the predefined impedance value is 50 Ohms.

29. A method for generating a volumetric image of target embedded in a test bed, the method comprising:
interrogating the test bed with a force resonating antenna along a first interrogation axis to identify an anomaly corresponding to the target;
verifying the identification of the anomaly with an interrogation of the test bed along a second interrogation axis orthogonal to the first interrogation axis;
deriving a first set of coordinates of the anomaly from the interrogation of the test bed along the first interrogation axis and a second set of coordinates of the anomaly from the interrogation of the test bed along the second interrogation axis;
transforming the first set of coordinates and the second set of coordinates to a depth coordinate values;
transforming the first set of coordinates, the second set of coordinates, and the depth coordinate values to a set of global coordinates; and
plotting magnitudes of each of the global coordinates in three dimensions.
